(19) United States
(12) Patent Application Publication
(10) Pub. No.: US 2015/0095098 A1
(43) Pub. Date: Apr. 2, 2015

(54) WORK MANAGEMENT METHOD AND MANAGEMENT SYSTEM

(71) Applicant: Hirohisa Miyazaki, Tokyo (JP)

(72) Inventor: Hirohisa Miyazaki, Tokyo (JP)

(73) Assignee: Hitachi, Ltd., Tokyo (JP)

(21) Appl. No.: 14/398,916

(22) PCT Filed: May 16, 2012
(86) PCT No.: PCT/JP2012/062547

§ 371 Date: Nov. 4, 2014

(51) Int. Cl. G06Q 10/06

(52) U.S. Cl. CPC G06Q 10/06316; G06Q 10/0633
USPC 705/7.27

(57) ABSTRACT

A management system manages the works performed to a predetermined target device. A management system stores, in a storage device, a first work definition showing a first work to be performed by an operator to a target device, a second work definition showing a second work for acquiring evidence for confirming a result of one first work among the one or more first works, and flow information including order information prescribing an execution order of the first work and the second work. The management system determines whether the timing has come to execute the second work based on the flow information and, when the timing has come to execute the second work, performs a support display for causing the operator to acquire evidence, and stores the evidence acquired based on the support display in the storage device by associating the acquired evidence with work flow information.

### TECHNICAL FIELD

The present invention relates to a technology of managing the works performed to a predetermined target device.

### BACKGROUND ART

Conventionally, a data center comprising servers and storages is known. As works related to the operation and management of this kind of data center, there are, for example, configuration work of the newly installed servers, configuration work of the OS of the servers, configuration work of the software installed in the servers, and configuration work related to the network to be coupled to the servers. These works, for example, are performed by an operator or automatically performed by a computer, but in either case the works need to be appropriately operated and managed.

For example, PTL 1 discloses a technology of storing, as logs, the file operations that were performed by a user via a computer as a method of managing a computer system.

### CITATION LIST

### Patent Literature

[PTL 1] WO 2012/001763

### SUMMARY OF INVENTION

### Technical Problem

With the technology disclosed in PTL 1, the operations performed by the user are directly stored as logs. Now, assumed is a case of determining whether the operational work performed by the user was appropriate by using the foregoing operation logs.

For example, while it is possible to determine whether the operational work performed by the user was appropriate as an operational work by comparing it with the operations that are expected in advance based on the foregoing operation log, when the assumed environment is different, there are cases where the operational work performed by the user is inappropriate as an operational work and the intended result cannot be attained with the operations that are expected in advance. Moreover, when operation logs are used, there are cases where the amount of stored operation logs becomes enormous, and it becomes difficult to verify the ultimate result.

### Solution to Problem

There is information (evidence) which enables the confirmation that the work was appropriately performed and that the expected result was obtained. Here, for example, as evidence in the configuration work of the OS or software in a server, there are, for example, an output result in response to an information acquisition command from the OS of the server, and a screen shot of the configuration screen showing the configuration contents of the OS or software. At least one of the following issues will arise when giving consideration to the management of evidence:

(1) accurate acquisition of evidence is demanded;

(2) deterioration in work efficiency due to the occurrence of work for acquiring evidence; and

(3) necessity to appropriately manage which evidence belongs to which work.

Thus, work management is executed with a management system that manages the works performed to a predetermined target device. A management system manages the works performed to a predetermined target device. A management system stores, in a storage device, a first work definition showing one or more first works to be performed by an operator to a target device, a second work definition showing a second work for acquiring evidence for confirming a result of one first work among the one or more first works, and flow information including order information prescribing an execution order of the first work and the second work. A management system determines whether the timing has come to execute the second work based on the flow information and, when the timing has come to execute the second work, performs a support display for causing the operator to acquire evidence, and stores the evidence acquired based on the support display in the storage device by associating the acquired evidence with work flow information.

### BRIEF DESCRIPTION OF DRAWINGS

FIG. 1 is a hardware configuration diagram of the computer system according to an embodiment.

FIG. 2 is a configuration diagram of the device to be operated according to an embodiment.

FIG. 3 is a configuration diagram of the Web client for an administrator according to an embodiment.

FIG. 4 is a configuration diagram of the Web client for an operator according to an embodiment.

FIG. 5 is a configuration diagram of the management server according to an embodiment.

FIG. 6 is a diagram showing an example of the flow management table according to an embodiment.

FIG. 7 is a diagram showing an example of the flow instance management table according to an embodiment.

FIG. 8 is a diagram showing an example of the evidence storage table according to an embodiment.

FIG. 9 is a diagram showing an example of the evidence management table according to an embodiment.

FIG. 10 is a diagram showing an example of the flow creation screen according to an embodiment.

FIG. 11 is a flowchart of the flow instance generation processing according to an embodiment.

FIG. 12 is a diagram showing an example of the flow execution screen according to an embodiment.

FIG. 13 is a flowchart of the progress control processing according to an embodiment.

FIG. 14 is a diagram showing a first example of the work indication screen according to an embodiment.

FIG. 15 is a flowchart of the evidence storage processing according to an embodiment.

FIG. 16 is a diagram showing a second example of the work indication screen according to an embodiment.

FIG. 17 is a flowchart of the evidence storage (command execution) processing according to an embodiment.

FIG. 18 is a diagram showing a first example of the evidence acquisition screen according to an embodiment.

FIG. 19 is a flowchart of the evidence storage (screen shot) processing according to an embodiment.

FIG. 20 is a diagram showing a second example of the evidence acquisition screen according to an embodiment.

FIG. 21 is a flowchart of the evidence display processing according to an embodiment.

FIG. 22 is a flowchart of the evidence display (command execution) processing according to an embodiment.

FIG. 23 is a diagram showing a first example of the evidence display screen according to an embodiment.

FIG. 24 is a flowchart of the evidence display (screen shot) processing according to an embodiment.

FIG. 25 is a diagram showing a second example of the evidence display screen according to an embodiment.

FIG. 26 is a flowchart of the evidence replacement (command execution) processing according to an embodiment.

FIG. 27 is a flowchart of the evidence replacement (screen shot) processing according to an embodiment.

FIG. 28 is a flowchart of the progress display processing according to an embodiment.

FIG. 29 is a diagram showing an example of the flow instance list screen according to an embodiment.

FIG. 30 is a diagram showing an example of the flow progress display screen according to an embodiment.

### DESCRIPTION OF EMBODIMENTS

An embodiment of the present invention is now explained with reference to the drawings. Note that the embodiment explained below is not intended to limit the invention pertaining to the claimed scope, and the various elements and their combinations explained in the embodiment are not necessarily all essential for the solution of the invention.

Note that, in the ensuing explanation, while various types of information may be explained using expressions such as “aaa table”, various types of information may also be expressed using a data structure other than tables. In order to indicate that there is no dependence on the data structure, “aaa table” may also be referred to as “aaa information”.

Moreover, in the ensuing explanation, there are cases where processing is explained using a “program” as the subject. Since predetermined processing is performed by suitably using storage resources (for example, a memory) and/or a communication interface device (for example, an NIC (Network Interface Card)) by a program being executed by a processor (for example, a CPU (Central Processing Unit)) included in a controller, the subject of the processing may be a program. Processing that is explained with a program as the subject may also be processing that is performed by a processor or a computer (for example, a management computer or the like) comprising that processor. Moreover, a controller may be the processor itself or include a hardware circuit that performs a part or the whole of the processing performed by the controller. A program may also be installed into the respective controllers from a program source. The program source may also be, for example, a program distribution server or a storage media.

In the ensuing explanation, an aggregate of one or more computers that manage a computer system and display information to be displayed is referred to as a management system. When the management computer is to display information to be displayed, then the management computer is a management system. Moreover, the combination of a management computer and a display computer is also a management system. Moreover, the same level of processing as a management computer may be realized with a plurality of computers for speeding up or increasing the reliability of the management processing. In the foregoing case, the plurality of computers (including a display computer when the display computer is to display information) are a management system. In this embodiment, the management server 10 is a management system.

Moreover, the act of the management system “displaying” information may be an act of a first computer in the management system displaying a screen or the like on a display device of the first computer, or an act of sending, to a second computer comprising a display device, information to be displayed such as a screen to be displayed on the display device. When the second computer receives the information to be displayed, the second computer may display a screen component or the like representing the information to be displayed on the display device.

The outline of the computer system according to an embodiment is foremost explained.

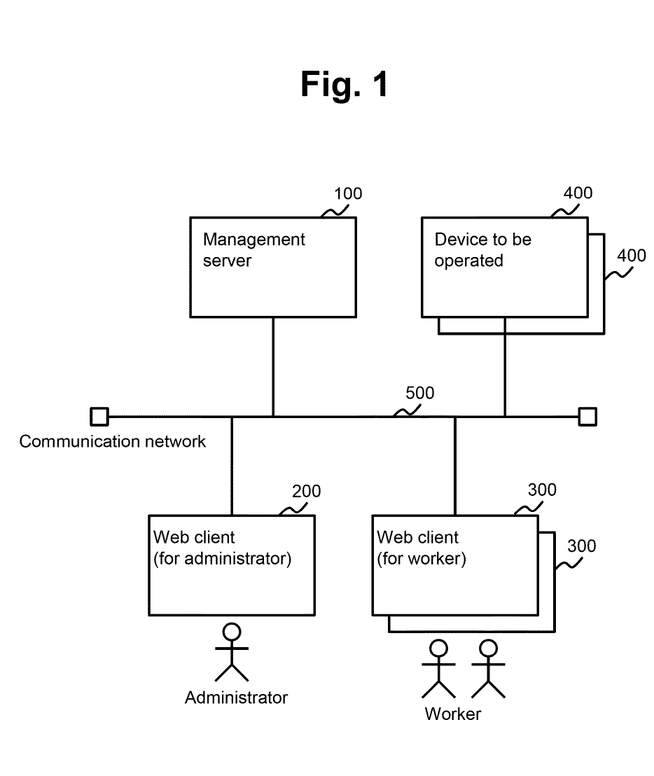

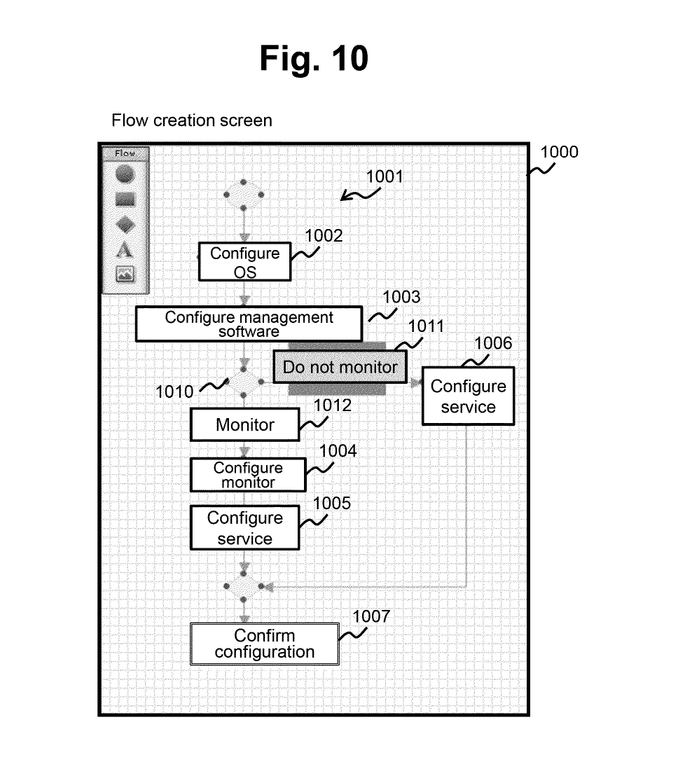

A management server 100 (refer to FIG. 1) in a computer system, for example, displays a flow creation screen 1000 shown in FIG. 10 on an administrator's Web client 200 or the like so that the administrator can create a workflow (for example, 1001) to become a template indicating a series of works. Based on the flow creation screen 100, the administrator can configure the definitions of works such as a configuration work as an example of a first work performed to a device to be operated 400, and a configuration work as an example of a second work for confirming the configuration of the device to be operated 400, as well as configure the order that these works are to be performed.

In the management server 100, a flow instance that materializes a workflow can be generated by configuring input values to parameters in the registered workflow. The management server 100 manages the progress of the respective works in the flow instance.

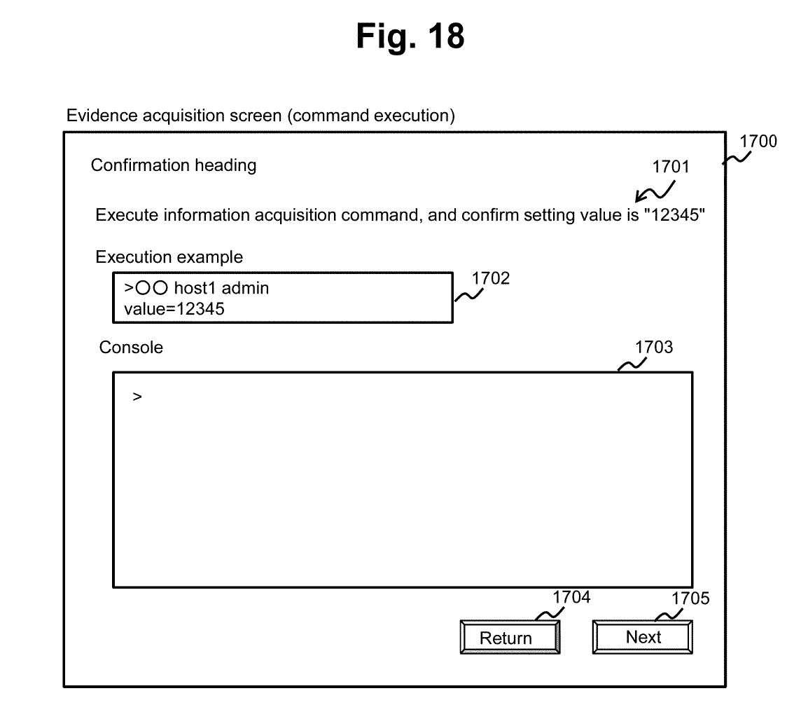

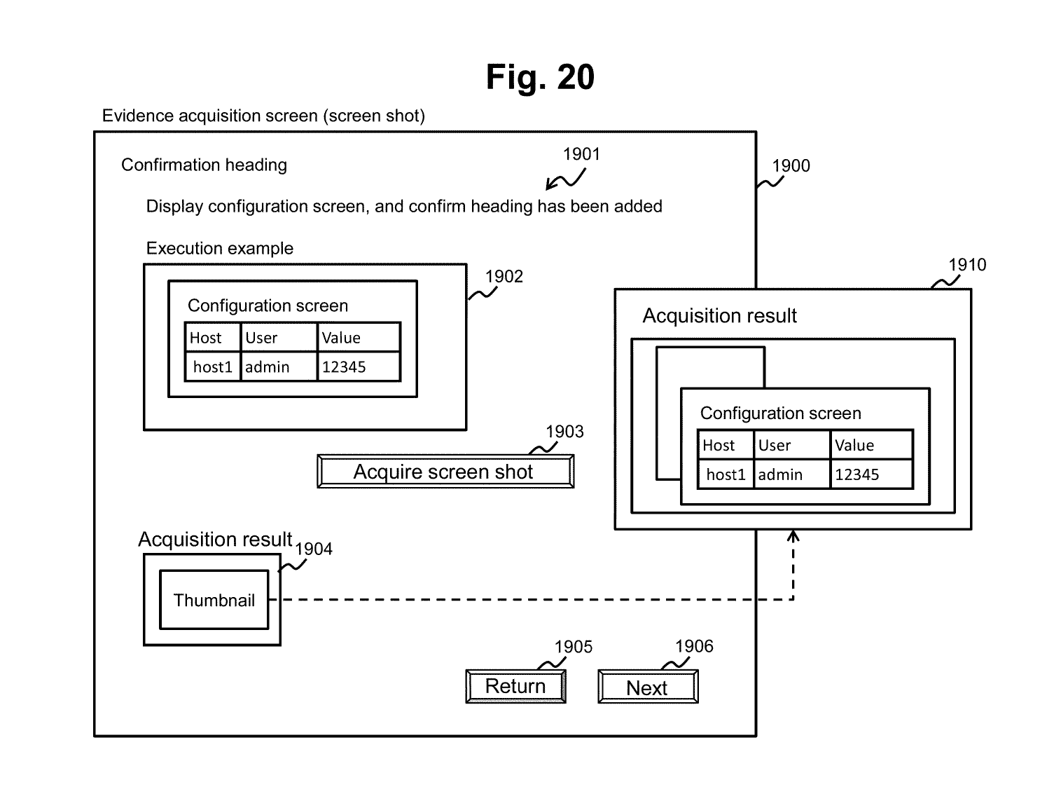

At the time of performing the confirmation work, the management server 100 displays, for example, an evidence acquisition screen (for example, FIG. 18, FIG. 20) for offering support to acquire evidence for confirming work in an operator's Web client 300. The operator can easily and appropriately acquire evidence by using the evidence acquisition screen.

Moreover, the management server 100 stores, in a storage resource 120, the evidence acquired with the evidence acquisition screen by associating the acquired evidence with the works in the flow instance. Thus, the operator or the administrator can appropriately comprehend which evidence corresponds to which work in the flow instance.

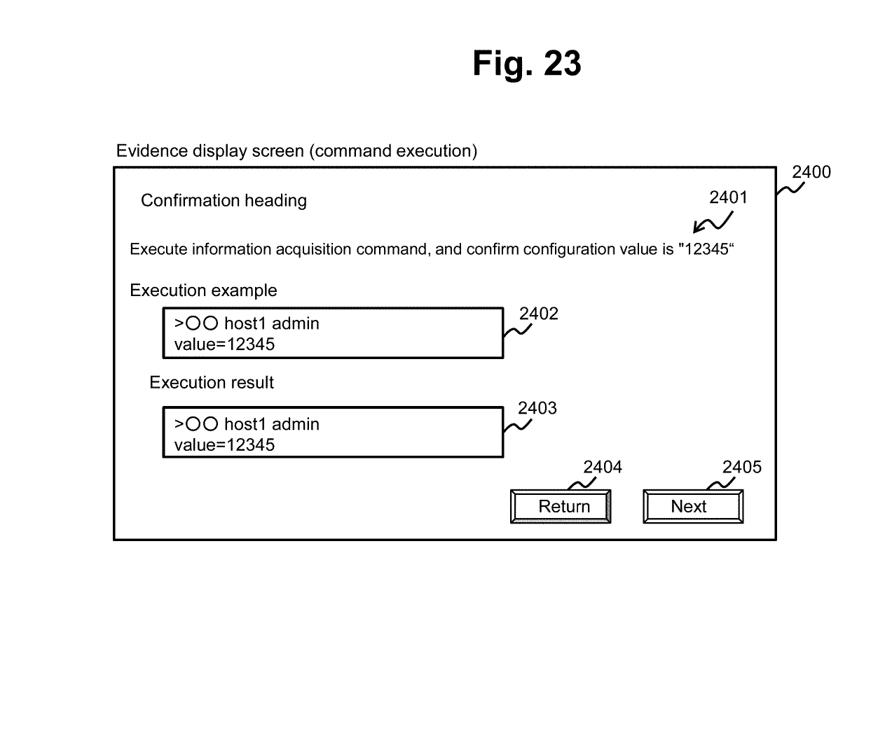

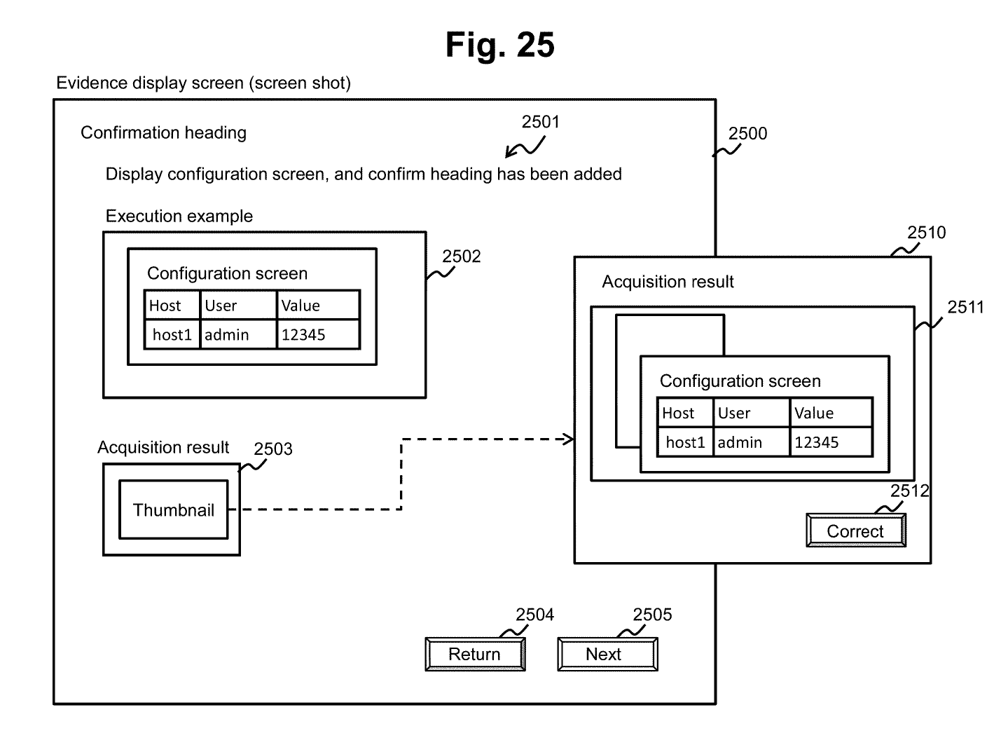

Moreover, the management server 100 displays, for example, an evidence display screen (for example, FIG. 23, FIG. 25) for confirming the acquired evidence and performing a correction indication on, for example, the operator's Web client 300. The operator can confirm whether the acquired evidence needs to be corrected based on the evidence display screen, and, when correction is required, perform the correction indication of the evidence from the evidence display screen.

When the management server 100 receives the correction indication, the management server 100 displays, for example, an evidence acquisition screen (for example, FIG. 18, FIG. 20) for re-acquiring evidence on, for example, the operator's Web client 300. The operator can re-acquire evidence based on the evidence acquisition. The management server 100 stores the re-acquired evidence as evidence of the works in the flow instance. Accordingly, the operator can appropriately replace the evidence in the works.

The computer system according to an embodiment is now explained in detail.

FIG. 1 is a hardware configuration diagram of the computer system according to an embodiment.

The computer system comprises the management server 100 as an example of the management computer, the Web client 200 for an administrator, the Web client 300 for one or more operators, and one or more devices to be operated 400 to be operated by the operator. The management server 100, the Web client 200, the Web client 300, and the device to be operated 400 are communicably connected, for example, via a communication network 500 such as a LAN (Local Area Network).

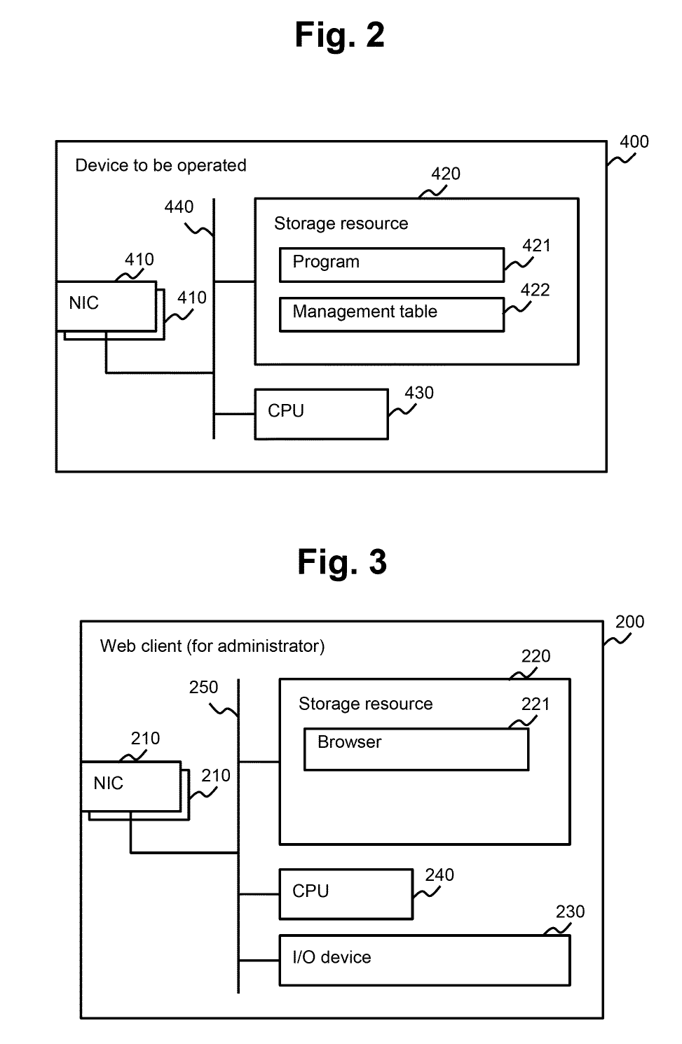

FIG. 2 is a configuration diagram of the device to be operated according to an embodiment.

The device to be operated 400 is, for example, a server, a printer, a storage apparatus or the like, and includes one or more NICs 410, a storage resource 420, a CPU 430, and a bus 440. The NIC 410, the storage resource 420, and the CPU 430 are connected via the bus 440.

The NIC 410 mediates the communication with other devices that are connected via the communication network 500. The storage resource 420 may be a memory such as a RAM, or a secondary storage device such as a hard disk drive (HDD), or a combination of a memory and a secondary storage device. The storage resource 420 stores a program 421 to be executed by the CPU 430, and various types of information (for example, management table 422) to be used by the CPU 430. The CPU 430 executes various types of processing by executing the programs stored in the storage resource 420 and using the various types of information stored in the storage resource 420.

FIG. 3 is a configuration diagram of the Web client for an administrator according to an embodiment.

The Web client 200 is a Web client to be used by the administrator for managing the computer system, and is configured, for example, from a general computer. The Web client 200 includes one or more NICs 210, a storage resource 220, an I/O device 230, a CPU 240, and a bus 250. The NIC 210, the storage resource 220, the I/O device 230, and the CPU 240 are connected via the bus 250.

The NIC 210 mediates the communication with other devices that are connected via the communication network 500. The storage resource 220 may be a memory such as a RAM, or a secondary storage device such as a hard disk drive (HDD), or a combination of a memory and a secondary storage device. The storage resource 220 stores a program to be executed by the CPU 240, and various types of information to be used by the CPU 240. In this embodiment, the storage resource 220 stores, as the program, a browser 221 for executing various types of processing relating to Web pages. The I/O device 230 includes an input device such as a keyboard or a mouse for inputting information to the Web client 200, and an output device such as a display for outputting various types of information. The CPU 240 executes various types of processing by executing the programs stored in the storage resource 220 and using the various types of information stored in the storage resource 220.

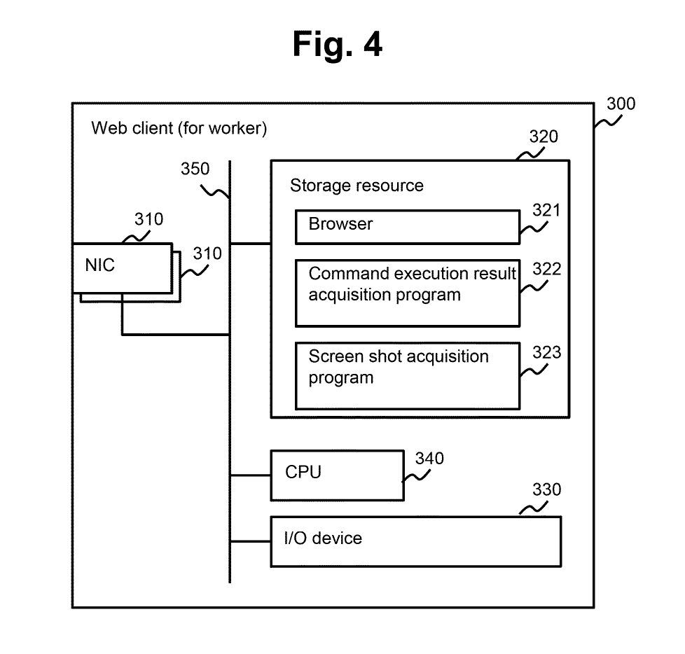

FIG. 4 is a configuration diagram of the Web client for an operator according to an embodiment.

The Web client 300 is a Web client to be used by the operator for executing works relating to the operation of the computer system, and is configured, for example, from a general computer. The Web client 300 includes one or more NICs 310, a storage resource 320, an I/O device 330, a CPU 340, and a bus 350. The NIC 310, the storage resource 320, the I/O device 330, and the CPU 340 are connected via the bus 350.

The NIC 310 mediates the communication with other devices that are connected via the communication network 500. The storage resource 320 may be a memory such as a RAM, or a secondary storage device such as a hard disk drive (HDD), or a combination of a memory and a secondary storage device. The storage resource 320 stores programs to be executed by the CPU 340, and various types of information to be used by the CPU 340. In this embodiment, the storage resource 320 stores, as the programs, a browser 321, a command execution result acquisition program 322, and a screen shot acquisition program 323. The browser 321 executes various types of processing related to Web pages. The command execution result acquisition program 322 executes processing of acquiring an execution result of a command that was executed to the device to be operated 400. The screen shot acquisition program 323 executes processing of acquiring a screen shot of a screen (for example, Web page) for displaying the configuration contents (result of configuration work) in the device to be operated 400.

The I/O device 330 includes an input device such as a keyboard or a mouse for inputting information to the Web client 300, and an output device such as a display for outputting various types of information. The CPU 340 executes various types of processing by executing the programs stored in the storage resource 320 and using the various types of information stored in the storage resource 320.

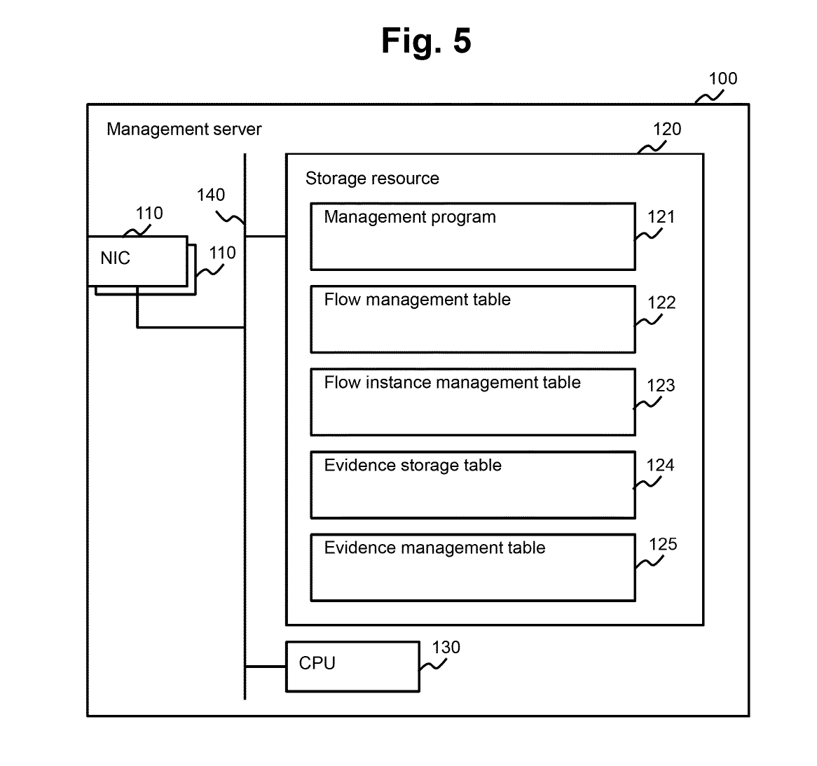

FIG. 5 is a configuration diagram of the management server according to an embodiment.

The management server 100 includes one or more NICs 110, a storage resource 120, a CPU 130, and a bus 140. The NIC 110, the storage resource 120, and the CPU 130 are connected via the bus 140. Note that the management server 100 may comprise an I/O device so that the administrator can directly use the management server 100.

The NIC 110 mediates the communication with other devices that are connected via the communication network 500. The storage resource 120 may be a memory such as a RAM, or a secondary storage device such as a hard disk drive (HDD), or a combination of a memory and a secondary storage device. The storage resource 120 stores programs to be executed by the CPU 130, and various types of information to be used by the CPU 130. In this embodiment, the storage resource 120 stores, as a program, a management program 121. Moreover, the storage resource 120 also stores a flow management table 122, a flow instance management table 123, an evidence storage table 124, and an evidence management table 125. Note that these tables (122 to 125) will be described later. The CPU 130 executes various types of processing by executing the programs stored in the storage resource 120 and using the various types of information stored in the storage resource 120.

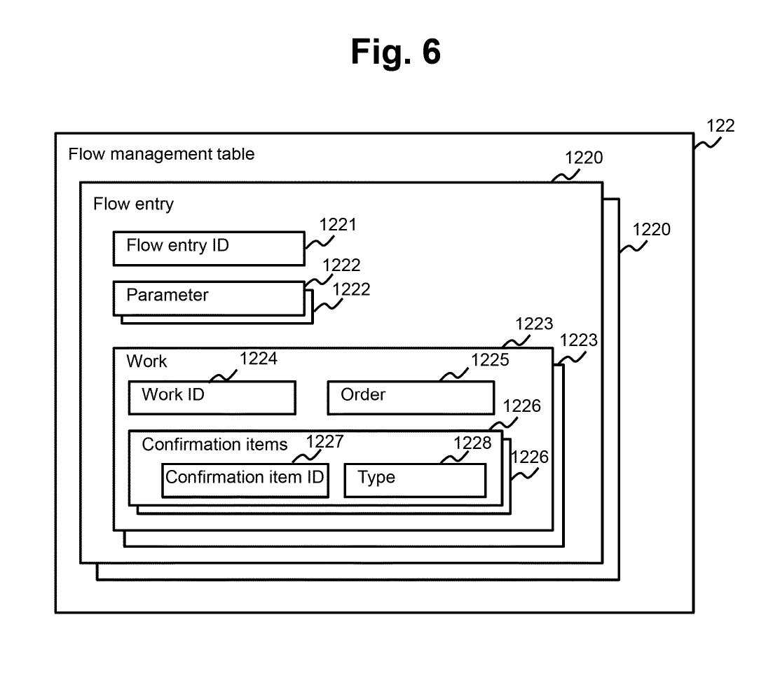

FIG. 6 is a diagram showing an example of the flow management table according to an embodiment.

The flow management table 122 is a table for managing one or more workflows to become a template. The flow management table 122 manages one entry (flow entry) 1220 for each workflow. The flow entry 1220 includes the fields of a flow entry ID 1221, one or more parameters 1222, and one or more works 1223.

The flow entry ID 1221 stores a flow entry ID for identifying the corresponding flow entry. The parameter 1222 stores information (for example, parameter name) for identifying the parameters in the workflow. The work 1223 is a field that is provided for each work of the corresponding workflow, and the contents of the field correspond to the work definition information (first work definition, or second work definition). The work 1223 includes the fields of a work ID 1224, an order 1225, and one or more confirmation items 1226. The work ID 1224 stores a work ID for identifying the corresponding work. The order 1225 stores order information showing the order of the corresponding works in the workflow. The confirmation item 1226 is a field that is provided for each confirmation work when there is any confirmation work in the corresponding work. The confirmation item 1226 includes the fields of a confirmation item ID 1227, and a type 1228. The confirmation item ID 1227 stores a confirmation item ID for identifying the corresponding confirmation item. The type 1228 stores a type of the confirmation item. As the types of confirmation items, there are, for example, a “command execution” of executing a predetermined command and confirming the result, and a “screen shot” of confirming a predetermined screen.

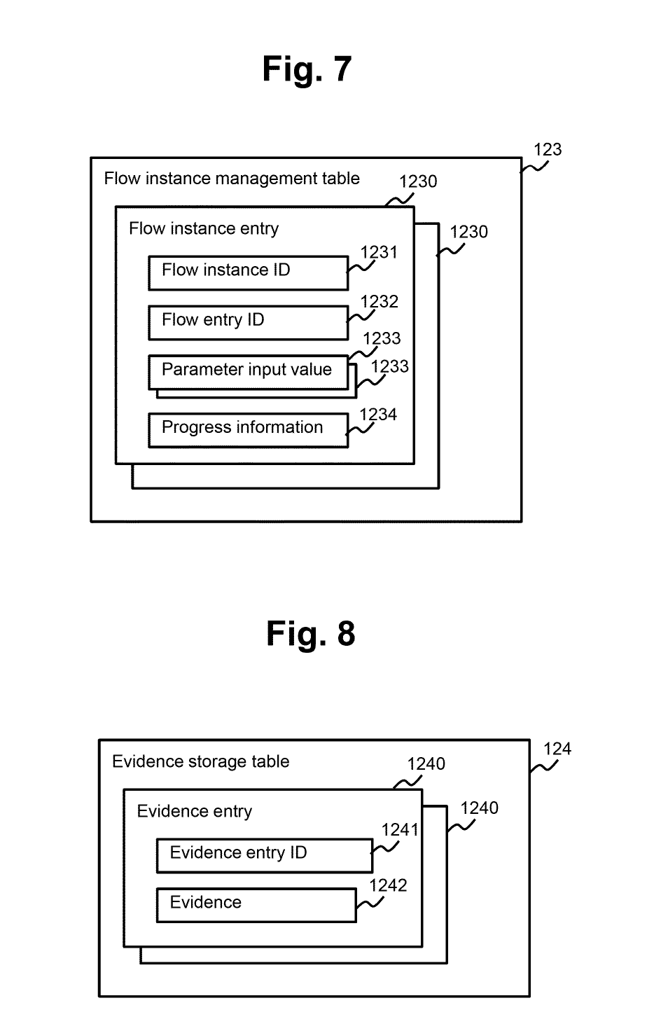

FIG. 7 is a diagram showing an example of the flow instance management table according to an embodiment.

The flow instance management table 123 is a table for managing the flow instance that was materialized based on the workflow, and manages one entry (flow instance entry) 1230 for each flow instance.

The flow instance entry 1230 includes the fields of a flow instance ID 1231, a flow entry ID 1232, one or more parameter input values 1233, and progress information 1234. The flow instance ID 1231 stores a flow instance ID for identifying the corresponding flow instance. The flow entry ID 1232 stores a flow entry ID corresponding to the workflow that was the basis of the corresponding flow instance. The parameter input value 1233 stores an input value in the flow instance of the parameter in the flow. The progress information 1234 stores progress information of the works in the corresponding flow instance.

FIG. 8 is a diagram showing an example of the evidence storage table according to an embodiment.

The evidence storage table 124 is a table for storing evidence for confirming the result of the works in the workflow, and manages one entry (evidence entry) 1240 for each piece of evidence.

The evidence entry 1240 includes the fields of an evidence entry ID 1241, and evidence 1242. The evidence entry ID 1241 stores an evidence entry ID for identifying the evidence entry. The evidence 1242 stores corresponding evidence, or a pointer for identifying the storage location of the evidence.

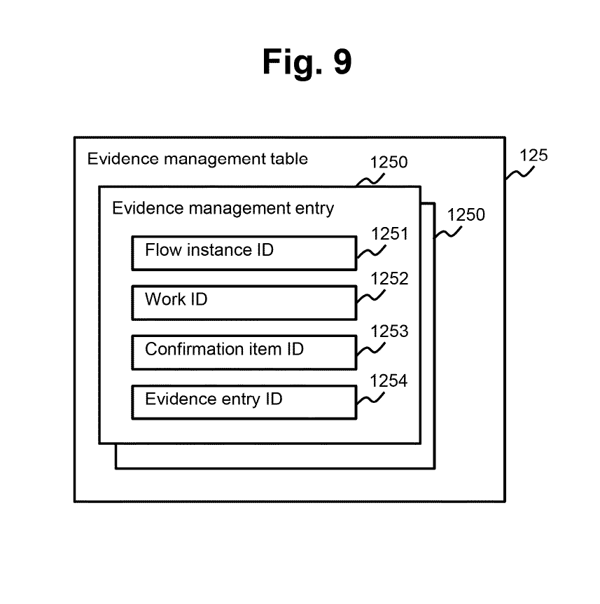

FIG. 9 is a diagram showing an example of the evidence management table according to an embodiment.

The evidence management table 125 is a table for managing the correspondence relation between the flow instance and the evidence, and manages one entry (evidence management entry) 1250 for each piece of evidence.

The evidence management entry 1250 includes the fields of a flow instance ID 1251, a work ID 1252, a confirmation item ID 1253, and an evidence entry ID 1254. The flow instance ID 1251 stores an ID of a flow instance (flow instance ID) associated with the corresponding evidence. The work ID 1252 stores information (work ID) for identifying the works in the flow instance associated with the corresponding evidence. The confirmation item ID 1253 stores information (confirmation item ID) for identifying the confirmation items in the works associated with the corresponding evidence. The evidence entry ID 1254 stores an ID of the evidence entry (evidence entry ID) of the corresponding evidence.

The processing operation in the computer system according to an embodiment is now explained.

FIG. 10 is a diagram showing an example of the flow creation screen according to an embodiment.

The flow creation screen 1000 is displayed on the I/O device 230 by the browser 221 of the Web client 200 based on the information sent from the management program 121 of the management server 100. The flow creation screen 1000 is displayed as a result of the browser 221 of the Web client 200 receiving a display indication of the flow creation screen from the administrator, and the browser 221 sending a display request of the flow creation screen to the management server 100.

The administrator can create the workflow 1001 to become a template by operating the I/O device 230 of the Web client 200 by viewing the flow creation screen 1000. In the flow creation screen 1000, work components (1002 to 1007) corresponding to one or more works maybe arranged as the workflow 1001 according to the order of works to be executed. Moreover, a branching component (1010) showing the branch of works may also be disposed in the workflow 1001. Branching conditions (1011, 1012) may be configured for the branch. Note that the detailed configuration (definition) of the respective works can also be configured by designating the work component of the target work. The management program 121 registers the flow entry 1220 of the flow management table 122 based on the workflow created with the flow creation screen 1000 as described above.

With the workflow 1001 shown in FIG. 10, the work of “OS configuration” 1002 as an example of a first work is performed, the work of “management software configuration” 1003 is performed, and, when monitoring is to be performed (condition 1012), the work of “monitor configuration” 1004, the work of “service configuration” 1005, and the work “configuration confirmation” 1007 as an example of a second work is performed. Meanwhile, when monitoring is not performed (condition 1011), the work of “service configuration” 1006 is performed, and the work of “configuration confirmation” 1007 is performed.

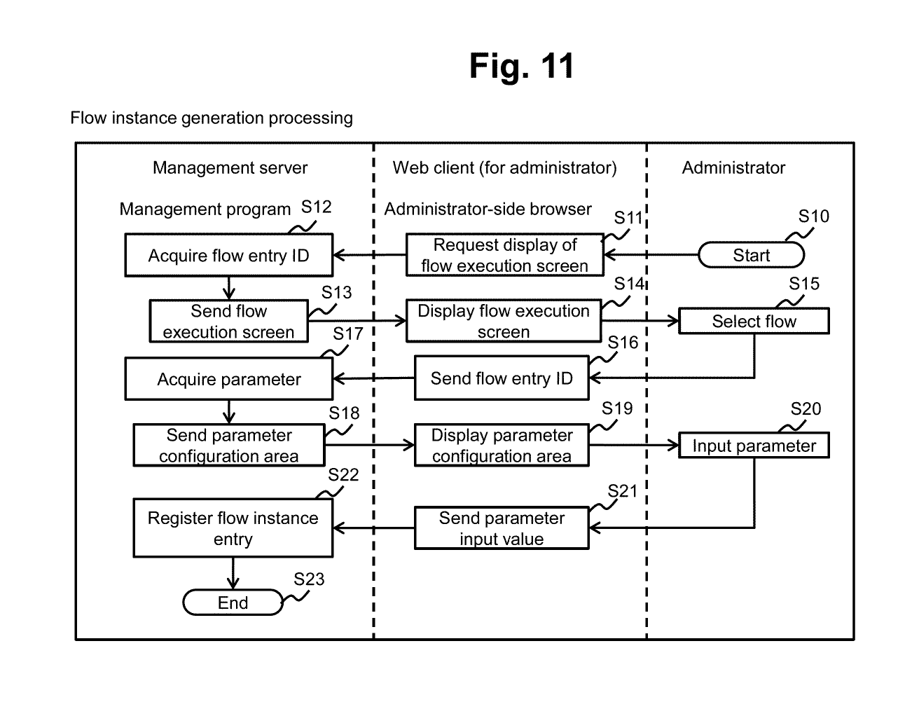

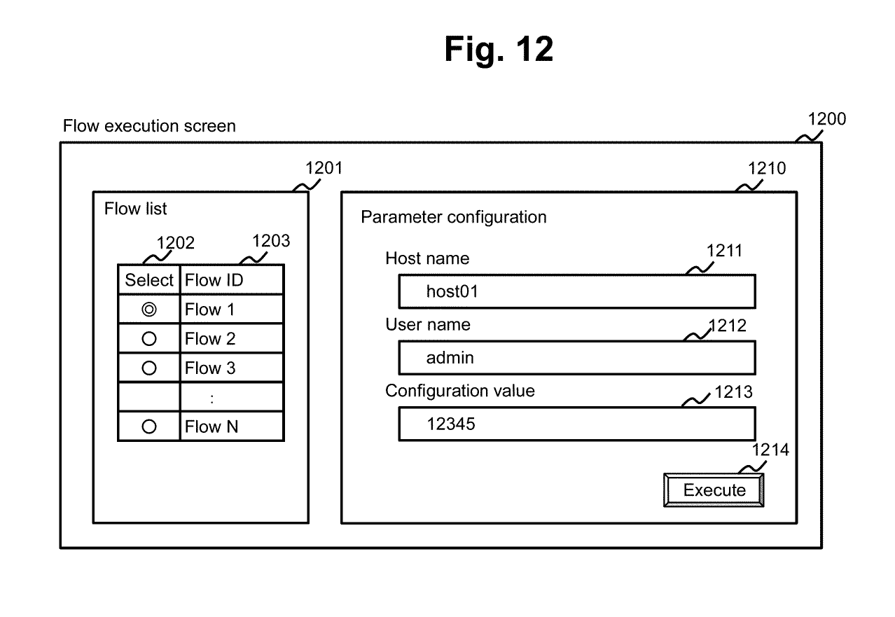

FIG. 11 is a flowchart of the flow instance generation processing according to an embodiment. FIG. 12 is a diagram showing an example of the flow execution screen according to an embodiment.

The flow instance generation processing is the processing of generating a flow instance that materialized the flow by deciding the values to configure the parameters of the flow to become the template.

When the administrator starts the operation by using the I/O device 230 of the Web client 200 performs a display request operation of the flow execution screen 1200 as shown in FIG. 12 (step S10), the browser 221 of the Web client 200 sends a display request of the flow execution screen 1200 to the management server 100 (step S11). The management program 121 of the management server 100 acquires from the flow management table 122 the flow entry ID of all flows (step S12), creates the flow execution screen 1200 (more specifically, data required for displaying the flow execution screen 1200), and sends the created flow execution screen 1200 to the Web client 200 (step S13).

Here, the flow execution screen 1200 includes, as shown in FIG. 12, a flow list area 1201, and a parameter configuration area 1210. The flow list area 1201 includes a selection area 1202 for selecting the target flow for which the parameter configuration area is to be displayed, and a flow ID area 1203 for displaying the flow entry ID. The parameter configuration area 1210 is an area for inputting the parameters of the flow that was selected in the flow list area 1201, and displays one or more parameter input areas (in FIG. 12, input areas 1211, 1212, 1213) for inputting one or more parameters in the flow, and an execution button 1214 for finalizing the input parameters; that is, indicating the execution of the generation of the flow instance that materialized the flow. Note that, in the flow execution screen 1200 generated in step S13, no flow of the selection area 1202 of the flow list area 1201 has been selected, and the parameter configuration area 1210 is of a non-displayed status.

When the browser 221 of the Web client 200 receives data of the flow execution screen 1200, it displays the flow execution screen 1200 on the I/O device 230 (step S14).

When the administrator uses the I/O device 230 of the Web client 200 and selects the flow in the selection area 1202 of the flow list area 1201 of the flow execution screen 1200 (step S15), the browser 221 identifies the flow entry ID of the selected flow, and sends the identified flow entry ID to the management server 100 (step S16).

The management program 121 of the management server 100 identifies the flow entry 1220 corresponding to the flow entry ID received from the flow management table 122, and acquires the parameter names stored in the parameter 1222 of the flow entry 1220 (step S17). Subsequently, the management program 121 creates the parameter configuration area 1210 including input areas (1211 and the like) for inputting the configuration values corresponding to the parameters based on the acquired parameters, and sends the created parameter configuration area 1210 to the Web client 200 (step S18).

The browser 221 of the Web client 200 displays the parameter configuration area 1210 on the flow execution screen 1200 (step S19).

When the administrator uses the I/O device 230 of the Web client 200 and inputs the configuration values of the parameters in the respective parameter input areas (1211 and the like) of the parameter configuration area 1210 of the flow execution screen 1200 and presses the execution button 1214 (step S20), the browser 221 sends the input configuration values (parameter input values) of the parameters to the management server 100 (step S21).

The management program 121 of the management server 100 registers, in the flow instance management table 123, the flow instance entry 1230 corresponding to the new flow instance including the received parameter input values and the like. Specifically, the management program 121 decides and stores a new flow instance ID showing a new flow instance in the flow instance ID 1231 of the newly registered flow instance entry 1230, stores, in the flow entry ID 1232, the flow entry ID corresponding to the flow which was selected in the flow list screen 1201 of the flow execution screen 120, and stores the received parameter input values in the parameter input value 1233.

The management program 121 thereafter ends the flow instance generation processing (step S23).

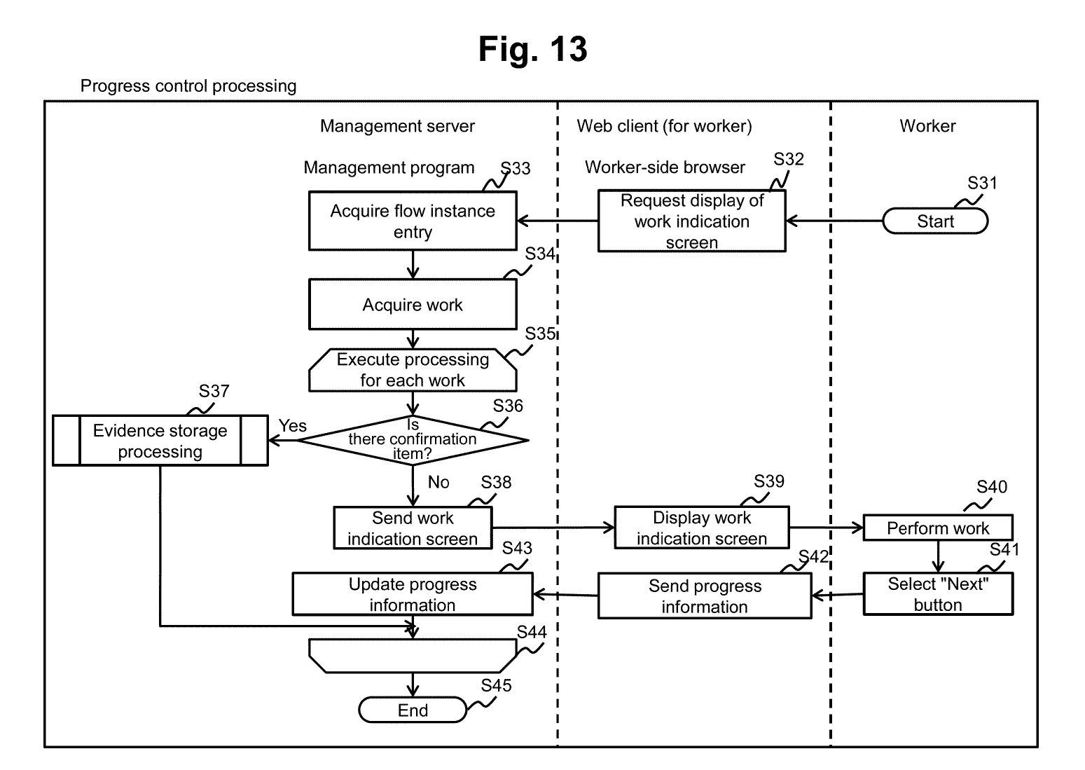

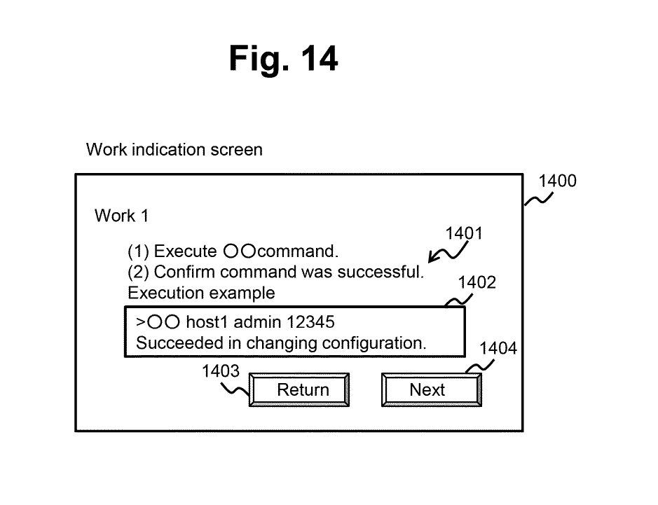

FIG. 13 is a flowchart of the progress control processing according to an embodiment. FIG. 14 is a diagram showing a first example of the work indication screen according to an embodiment.

The progress control processing is the processing that is executed when an operator executes works according to the flow instance.

When the operator starts the operation by using the I/O device 330 of the Web client 300 and performs a display request operation of the work indication screen (step S31), the browser 321 of the Web client 300 sends a display request of the work indication screen to the management server 100 (step S32). The management program 121 of the management server 100 acquires the flow instance entry 1230 from the flow instance management table 123 (step S33), acquires, from the flow management table 122, the flow entry 1220 in which the value of the flow entry ID 1221 coincides with the value of the flow entry ID 1232 in the acquired flow instance entry 1230, and acquires the work 1223 from that flow entry 1220 (step S34).

Subsequently, the management program 121 executes the processing based on the management program 121 up to step S44 to each of the acquired works 1223 (step S35).

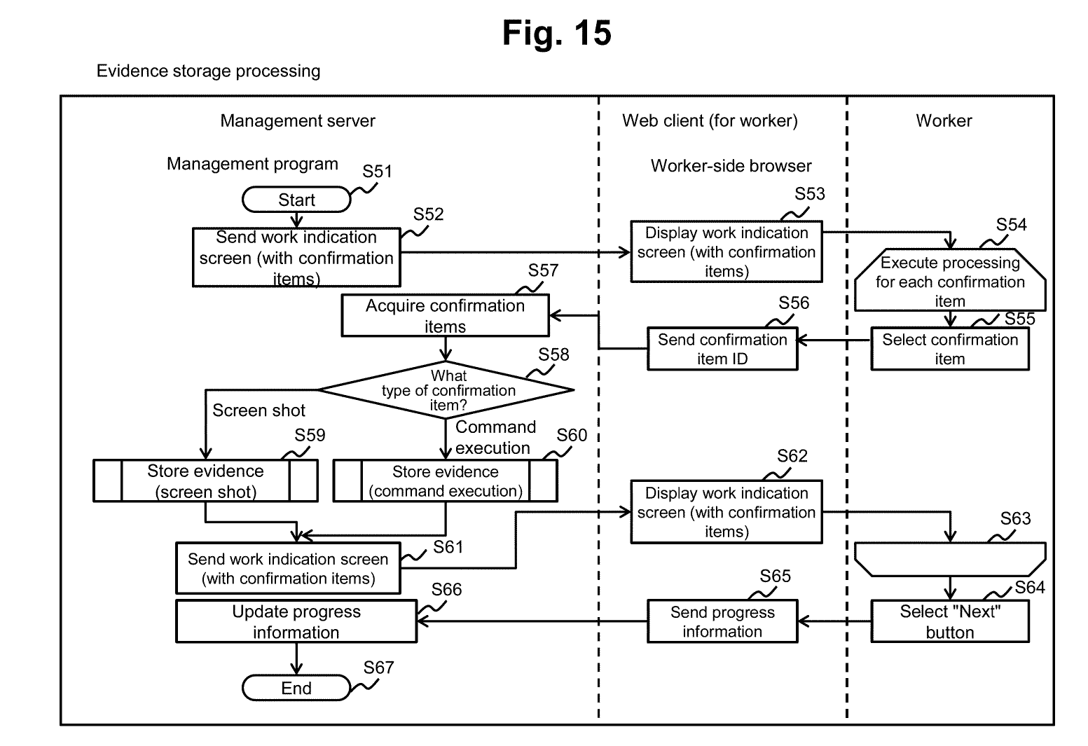

The management program 121 determines whether there is a confirmation item in the confirmation item 1226 in the work 1223 (step S36), and, when there is a confirmation item (step S36: Yes), executes the evidence storage processing shown in FIG. 15 (step S37), and advances the processing to step S44.

Meanwhile, when there is no confirmation item (step S36: No), the management program 121 sends the work indication screen 1400 shown in FIG. 14 (specifically, data required for displaying the work indication screen 1400) to the Web client 300 (step S38).

Here, the work indication screen 1400 displays, as shown in FIG. 14, a work description area 1401, an execution example area 1402, a return button 1403, and a next button 1404. The work description area 1401 shows the contents to be executed by the operator in the work. The execution example area 1402 displays an example (execution example) that is assumed to be displayed on the Web client 300 when the operator executes the work. Based the execution example of the execution example area 1402, the operator can easily and appropriately comprehend whether the result of the executed work is appropriate. Note that, as the execution example, a general execution example may be used in cases where similar work is performed, or an execution example that is in line with the current work may be used. As an execution example that is in line with the current work, for example, the values of the actual parameters in the current work may be displayed at the portion where the parameter values are to be displayed. By using an execution example that is in line with the actual work, it is possible to easily and appropriate determine the suitability upon actually performing the work. The return button 1403 is a button to be pressed when the corresponding work is not to be executed yet. The next button 1404 is a button to be pressed when the corresponding work has been executed and proceeding to the next work.

When the browser 321 of the Web client 300 receives data of the work indication screen 1400 from the management server 100, it displays the work indication screen 1400 on the I/O device 330 based on the received data (step S39). The operator thereafter performs the work according to the work indication screen 1400 displayed on the I/O device 330 (step S40).

When the work performed by the operator is complete and the operator uses the I/O device 330 of the Web client 300 and presses the next button 1404 of the work indication screen 1400 (step S41), the browser 321 sends progress information showing that the corresponding work has been completed to the management server 100 (step S42).

When the management program 121 of the management server 100 receives the progress information, it stores the received progress information in the progress information 1234 of the corresponding flow instance entry 1230 of the flow instance management table 123 (step S43), and advances the processing to step S44.

In step S44, when the management program 121 of the management server 100 has not yet executed the processing up to step S44 to all works acquired in step S34, it executes the processing of step S35 onward to the works that have not yet been processed, and ends the progress control processing when all works have been processed (step S45).

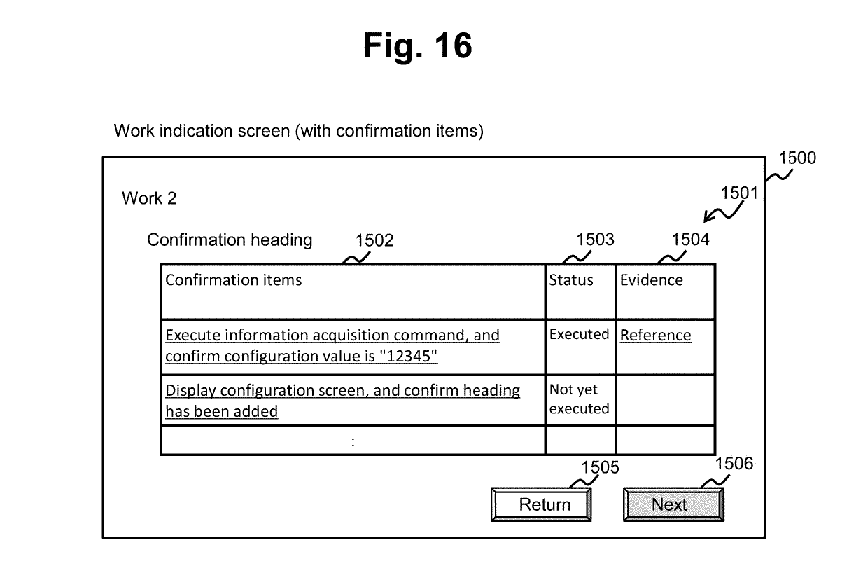

FIG. 15 is a flowchart of the evidence storage processing according to an embodiment. FIG. 16 is a diagram showing a second example of the work indication screen according to an embodiment.

The evidence storage processing is the processing of step S37 in FIG. 13. When the management program 121 of the management server 100 starts the processing (step S51), it creates the work indication screen (work indication screen (with confirmation item)) 1500 in cases when there is a configuration item shown in FIG. 16, and sends the created work indication screen 1500 to the operator's Web client 300 (step S52).

Here, the work indication screen 1500 displays, as shown in FIG. 16, a confirmation heading area 1501, a return button 1505, and a next button 1506. The confirmation heading area 1501 displays a confirmation item area 1502, a status area 1503, and an evidence area 1504 for each confirmation item.

The confirmation item area 1502 displays the contents of the confirmation item. In this embodiment, the operator can designate the confirmation item to which the confirmation work is to be performed by indicating the selection among the displayed confirmation items. The status area 1503 stores a status of work of the corresponding confirmation item. As the status of work, there is, for example, “Executed” showing that the work has been executed, or “Not yet executed” showing that the work has not yet been executed. The evidence area 1504 stores a link for referring to the evidence acquired in the work of the corresponding confirmation item. Note that the evidence area 1504 may also display the evidence.

The return button 1505 is a button to be pressed when the corresponding work is not to be executed yet. The next button 1506 is a button to be pressed when the corresponding work has been executed and proceeding to the next work. Note that, in this embodiment, the next button 1506 cannot be selected unless the status area 1503 of all confirmation items is “Executed”.

When the browser 321 of the Web client 300 receives data of the work indication screen 1500 from the management server 100, it displays the work indication screen 1500 on the I/O device 330 based on the received data (step S53).

Here, the operator executes the processing of the operator in steps S54 to S63 for each confirmation item.

When anyone of the confirmation items of the work indication screen 1500 is pressed based on the operator's operation of the I/O device 330 of the Web client 300 (step S55), the browser 321 sends the confirmation item ID corresponding to the pressed confirmation item to the management server 100 (step S56).

When the management program 121 of the management server 100 receives the confirmation item ID, it acquires, from the flow management table 122, the confirmation item 1226 storing the same configuration item ID as the foregoing confirmation item ID (step S57), and determines the type of confirmation item based on the value of the type 1228 in the confirmation item 1226 (step S58).

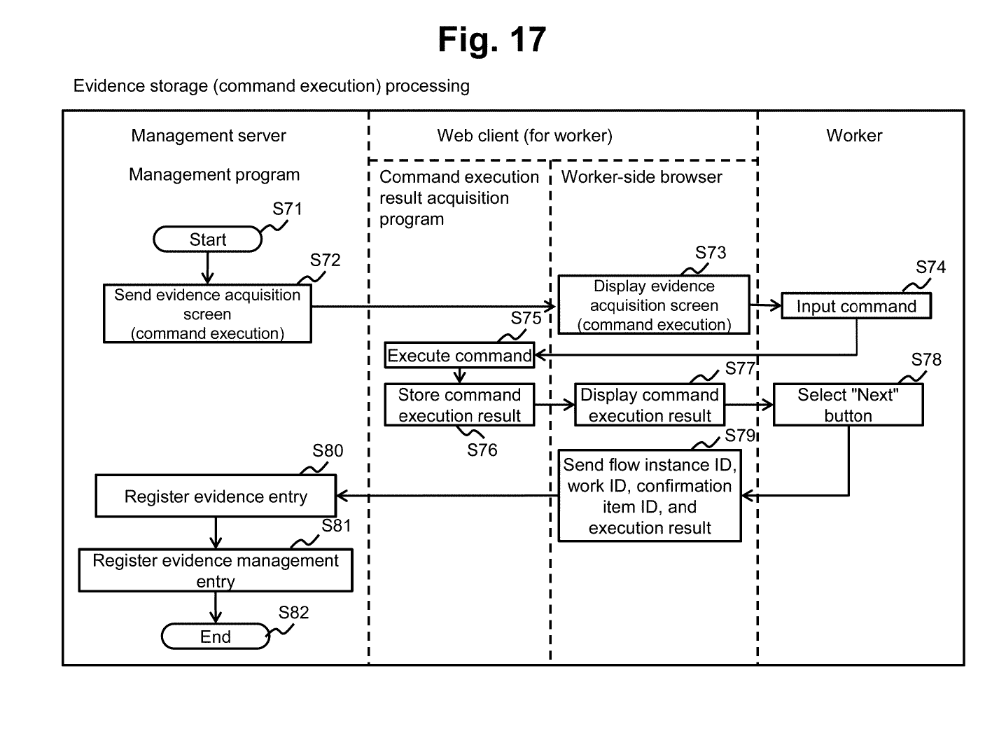

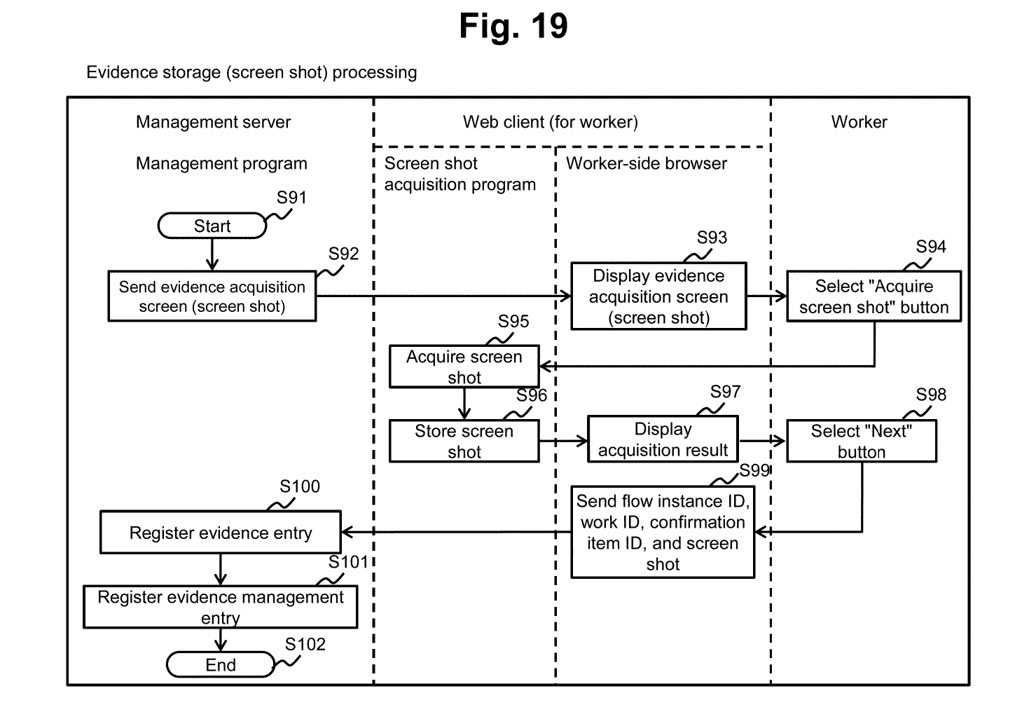

When the type is consequently a screen shot (step S58: screen shot), the management program 121 of the management server 100 executes the evidence storage processing (evidence storage (screen shot) processing) related to the screen shot shown in FIG. 19 (step S59), and, after the foregoing processing, advances the processing to step S61. Meanwhile, when the type is a command execution (step S58: command execution), the management program 121 of the management server 100 executes the evidence storage processing (evidence storage (command execution) processing) related to the command execution shown in FIG. 17 (step S60), and after the foregoing processing, advances the processing to step S61.

In step S61, the management program 121 creates the work indication screen 1500 based on the execution result of step S59 or step S60, and sends the created work indication screen 1500 to the operator's Web client 300. Here, in the work indication screen 1500, “Executed” is configured in the status area 1503 corresponding to the executed confirmation item, and a link for referring to the evidence corresponding to the executed confirmation item is stored in the corresponding evidence area 1504.

When the browser 321 of the Web client 300 receives data of the work indication screen 1500 from the management server 100, it displays the work indication screen 1500 on the I/O device 330 based on the received data (step S62). Here, when a different confirmation item has not yet been completed, the operator executes the processing of the operator in steps S54 to S63 to that confirmation item. Meanwhile, when all confirmation items have been completed, the operator presses the next button 1506, and advances to the subsequent step.

When the operator uses the I/O device 330 of the Web client 300 and presses the next button 1506 of the work indication screen 1500 (step S64), the browser 321 sends progress information showing that the corresponding work has been completed to the management server 100 (step S65).

When the management server 100 receives the progress information, it stores the received progress information in the progress information 1234 of the corresponding flow instance entry 1230 of the flow instance management table 123 (step S66), and ends the evidence storage processing (step S67).

FIG. 17 is a flowchart of the evidence storage (command execution) processing according to an embodiment. FIG. 18 is a diagram showing a first example of the evidence acquisition screen according to an embodiment.

The evidence storage (command execution) processing is the processing of step S60 in FIG. 15. When the management program 121 of the management server 100 starts the processing (step S71), it creates the evidence acquisition screen (evidence acquisition screen (command execution)) 1700 upon the command execution shown in FIG. 18, and sends the created evidence acquisition screen 1700 to the operator's Web client 300 (step S72).

Here, the evidence acquisition screen 1700 displays, as shown in FIG. 18, a confirmation item area 1701, an execution example area 1702, a console area 1703, a return button 1704, and a next button 1705.

The confirmation item area 1701 displays the contents of the confirmation item. The execution example area 1702 displays an example (execution example) that is assumed to be displayed when the operator executes the work. Based the execution example of the execution example area 1702, the operator can easily and appropriately comprehend whether the result of the executed work is appropriate. Note that, as the execution example, a general execution example may be used in cases where similar work is performed, or an execution example that is in line with the current work may be used. As an execution example that is in line with the current work, for example, the values of the actual parameters in the current work may be displayed at the portion where the parameter values are to be displayed. By using an execution example that is in line with the actual work, it is possible to easily and appropriate determine the suitability upon actually performing the work. The console area 1703 is an area for inputting a command to be executed by the target device to be operated 400 and displaying the result of that command. The return button 1704 is a button to be pressed when the corresponding work is not to be executed yet. The next button 1705 is a button to be pressed when the corresponding work has been executed and proceeding to the next work.

When the browser 321 of the Web client 300 receives data of the evidence acquisition screen 1700 from the management server 100, it displays the evidence acquisition screen 17000 on the I/O device 330 (step S73).

Here, the operator inputs a command to the console area 1703 of the evidence acquisition screen 1700 and indicates the execution of the command. Here, as the command to be input, for example, there is a command for causing the OS of the device to be operated 400 to display the contents of the configuration in the confirmation work of confirming the results of the configuration work in the OS of the device to be operated 400.

When a command is input to the console area 1703 of the evidence acquisition screen 1700 by the operator operating the I/O device 330 of the Web client 300 (step S74), the command execution result acquisition program 322 of the Web client 300 causes a predetermined device to be operated 400 to execute the input command, acquires the execution result of the command of that device to be operated 400 (step S75), stores the execution result in the storage resource 320, and notifies the execution result of the command to the browser 321 (step S76).

The browser 321 displays the notified execution result on the console area 1703 of the evidence acquisition screen 1700 (step S77). Consequently, the operator can compare the contents of the execution example area 1702 of the evidence acquisition screen 1700 and the execution result displayed in the console area 1703, and thereby easily and appropriately perform the confirmation work for determining whether the work was performed appropriately.

When the user uses the I/O device 330 of the Web client 300 and presses the next button 1705 (step S78), the browser 321 sends, to the management server 100, the flow instance ID, the work ID, the confirmation item ID, and the command execution result relating to the corresponding confirmation work (step S79).

The management program 121 of the management server 100 acquires the flow instance ID, the work ID, the confirmation item ID, and the command execution result, and registers the evidence entry 1240 regarding the command execution result in the evidence storage table 124 (step S80). Here, the newly allocated evidence ID is stored in the evidence entry ID 1241 of the evidence entry 1240, and information for identifying the area where the command execution result (evidence) is to be stored is stored in the evidence 1242. Note that the execution result is stored, for example, in a predetermined area of the storage resource 120 of the management server 100. The storage resource for storing the execution result is not limited to the storage resource 120 of the management server 100, and may be any accessible storage resource.

Moreover, the management program 121 of the management server 100 registers the evidence management entry 1250 relating to the corresponding evidence in the evidence management table 125 (step S81), and ends the evidence storage (command execution) processing (step S82). Here, the received flow instance ID, work ID, and confirmation item ID are respectively stored in the flow instance ID 1251, the work ID 1252, and the confirmation item ID 1253 of the evidence management entry 1250, and the evidence entry ID registered in step S80 is stored in the evidence entry ID 1254. It is thereby possible to identify the evidence entry ID corresponding to a certain confirmation item of a certain work of a certain flow instance based on the evidence management table 125, and the evidence can be identified based on the evidence storage table 124.

According to the foregoing evidence storage (command execution) processing, when the operator inputs a command and executes work and confirms the executed work, the result thereof is automatically registered in the management server 100. Thus, there will be no omission of evidence, and extra work will not be required for registering the evidence. Moreover, since the evidence can be associated with the flow instance (more specifically, with the work therein), the evidence can be appropriately managed.

FIG. 19 is a flowchart of the evidence storage (screen shot) processing according to an embodiment. FIG. 20 is a diagram showing a second example of the evidence acquisition screen according to an embodiment.

The evidence storage (screen shot) processing is the processing of step S59 in FIG. 15. When the management program 121 of the management server 100 starts the processing (step S91), it creates the evidence acquisition screen (evidence acquisition screen (screen shot command execution)) 1900 based on the screen shot shown in FIG. 20, and sends the created evidence acquisition screen 1900 to the operator's Web client 300 (step S92).

Here, the evidence acquisition screen 1900 displays, as shown in FIG. 20, a confirmation item area 1901, an execution example area 1902, a screen shot acquisition button 1903, an acquisition result area 1904, a return button 1905, and a next button 1906.

The confirmation item area 1901 displays the contents of the confirmation item. The execution example area 1902 displays an example (execution example) that is assumed to be displayed on the Web client 300 when the operator executes the work. Based the execution example of the execution example area 1902, the operator can easily and appropriately comprehend whether the result of the executed work is appropriate. Note that, as the execution example, a general execution example maybe used in cases where similar work is performed, or an execution example that is in line with the current work may be used. As an execution example that is in line with the current work, for example, the values of the actual parameters in the current work may be displayed at the portion where the parameter values are to be displayed. By using an execution example that is in line with the actual work, it is possible to easily and appropriate determine the suitability upon actually performing the work. The screen shot acquisition button 1903 is a button to be pressed for indicating the acquisition of the screen shot of the screen for confirming the configuration information of a predetermined device to be operated 400.

The acquisition result area 1904 is an area for displaying the thumbnail of the acquired screen shot. Note that, when the thumbnail is pressed, the acquisition result screen 1910 is displayed on the evidence acquisition screen 1900. The acquired screen shot is displayed on the acquisition result screen 1910. The return button 1905 is a button to be pressed when the corresponding work is not to be executed yet. The next button 1906 is a button to be pressed when the corresponding work has been executed and proceeding to the next work.

When the browser 321 of the Web client 300 receives data of the evidence acquisition screen 1900 from the management server 100, it displays the evidence acquisition screen 19000 on the I/O device 330 based on the received data (step S93).

Here, the operator presses the screen shot acquisition button 1903 of the evidence acquisition screen 1900 and indicates the acquisition of the screen shot of the configuration screen of the device to be operated 400.

When the screen shot acquisition button 1903 of the evidence acquisition screen 1900 is pressed by the operator operating the I/O device 330 of the Web client 300 (step S94), the screen shot acquisition program 323 of the Web client 300 acquires, from the device to be operated 400, and displays a screen for displaying the configuration information of the device to be operated 400, acquires the screen shot of that screen (step S95), stores the screen shot in the storage resource 320, and delivers the screen shot to the browser 321 (step S96).

The browser 321 displays the thumbnail of the notified screen shot in the acquisition result area 1904 of the evidence acquisition screen 1900 (step S97). It is thereby possible to display the acquisition result screen 1910 when the operator presses the acquisition result area 1904 of the evidence acquisition screen 1900, and the operator can thereby compare the contents of the execution example area 1902 and the execution result (screen shot) displayed on the acquisition result screen 1910, and thereby easily and appropriately perform the confirmation work for determining whether the work was performed appropriately.

When operator uses the I/O device 330 of the Web client 300 and presses the next button 1906 (step S98), the browser 321 sends, to the management server 100, the flow instance ID, the work ID, the confirmation item ID, and the screen shot related to the corresponding confirmation work (step S99).

The management program 121 of the management server 100 acquires the flow instance ID, the work ID, the confirmation item ID, and the screen shot, and registers the evidence entry 1240 regarding the screen shot in the evidence storage table 124 (step S100). Here, the newly allocated evidence ID is stored in the evidence entry ID 1241 of the evidence entry 1240, and information for identifying the area where the screen shot is to be stored is stored in the evidence 1242. Note that the screen shot is stored, for example, in a predetermined area of the storage resource 120 of the management server 100. The storage resource for storing the execution result is not limited to the storage resource 120 of the management server 100, and may be any accessible storage resource.

Moreover, the management program 121 of the management server 100 registers the evidence management entry 1250 relating to the corresponding evidence in the evidence management table 125 (step S101), and ends the evidence storage (screen shot) processing (step S102). Here, the received flow instance ID, work ID, and confirmation item ID are respectively stored in the flow instance ID 1251, the work ID 1252, and the confirmation item ID 1253 of the evidence management entry 1250, and the evidence entry ID registered in step S100 is stored in the evidence entry ID 1254. It is thereby possible to identify the evidence entry ID corresponding to a certain confirmation item of a certain work of a certain flow instance based on the evidence management table 125, and the evidence can be identified based on the evidence storage table 124.

According to the foregoing evidence storage (screen shot) processing, the screen shot as evidence can be easily acquired by the operator pressing the screen shot acquisition button 1903, and the result thereof is registered in the management server 100. Thus, there will be no omission of evidence, and extra work will not be required for registering the evidence. Moreover, since the evidence can be associated with the flow instance (more specifically, with the work therein), the evidence can be appropriately managed.

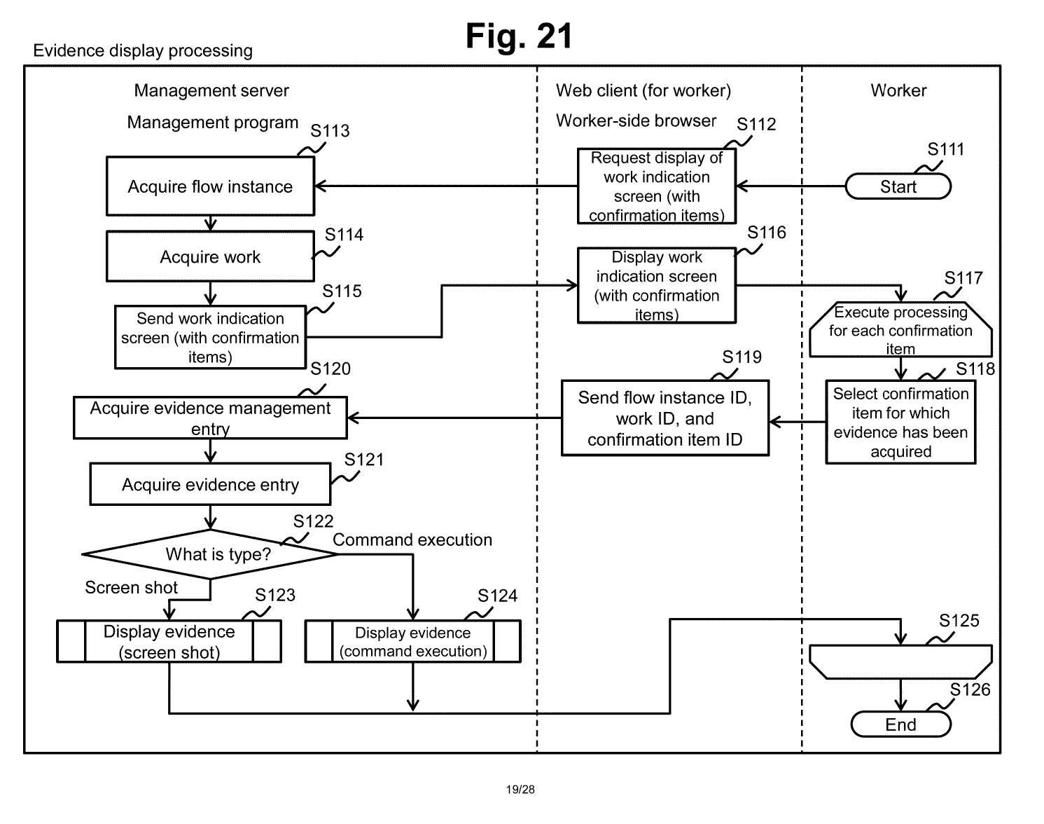

FIG. 21 is a flowchart of the evidence display processing according to an embodiment.

The evidence display processing is the processing that is executed when the operator is to confirm the evidence.

When the operator starts the operation by using the I/O device 330 of the Web client 300 and performs a display request operation of the work indication screen 1500 (step S111), the browser 321 of the Web client 300 sends a display request of the work indication screen 1500 to the management server 100 (step S112). Here, a display request includes, for example, the ID of the flow instance to be displayed. The management program 121 of the management server 100 acquires the corresponding flow instance entry 1230 from the flow instance management table 123 (step S113), acquires, from the flow management table 122, the flow entry 1220 in which the value of the flow entry ID 1221 coincides with the value of the flow entry ID 1232 in the acquired flow instance entry 1230, and acquires the work 1223 from that flow entry 1220 (step S114).

In step S115, the management program 121 creates the work indication screen 1500 based on the execution result of step S113, step S114, and sends the created work indication screen 1500 to the operator's browser 300.

When the browser 321 of the Web client 300 receives data of the work indication screen 1500 from the management server 100, it displays the work indication screen 1500 on the I/O device 330 based on the received data (step S116).

Here, the operator executes the processing of the operator in steps S117 to S125 for each confirmation item.

When any one of the confirmation items for which evidence has been acquired in the work indication screen 1500 by the operator operating the I/O device 330 of the Web client 300 (step S118), the browser 321 sends, to the management server 100, the confirmation item ID corresponding to the pressed confirmation item, and the flow instance ID and the work ID including that confirmation item (step S119).

When the management program 121 of the management server 100 receives the flow instance ID, the work ID, and the confirmation item ID, it acquires, from the evidence management table 125, the evidence management entry 1250 corresponding to the received flow instance ID, work ID, and confirmation item ID (step S120), and acquires the evidence entry 1240 of the evidence storage table 124 having a value corresponding to the evidence entry ID of the evidence management entry 125 (step S121). Subsequently, the management program 121 determines the type of confirmation item of the corresponding evidence (step S122). Specifically, the management program 121 determines the type of confirmation by identifying the value of the type 1228 corresponding to the flow instance ID, the work ID, and the confirmation item ID received from the flow management table 122.

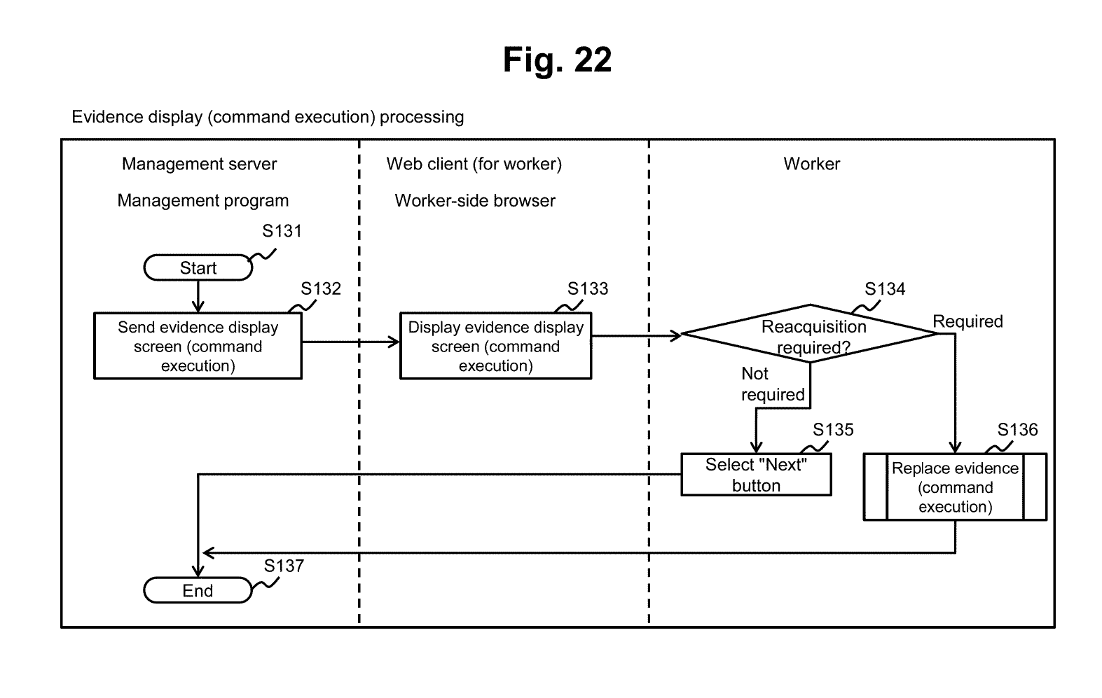

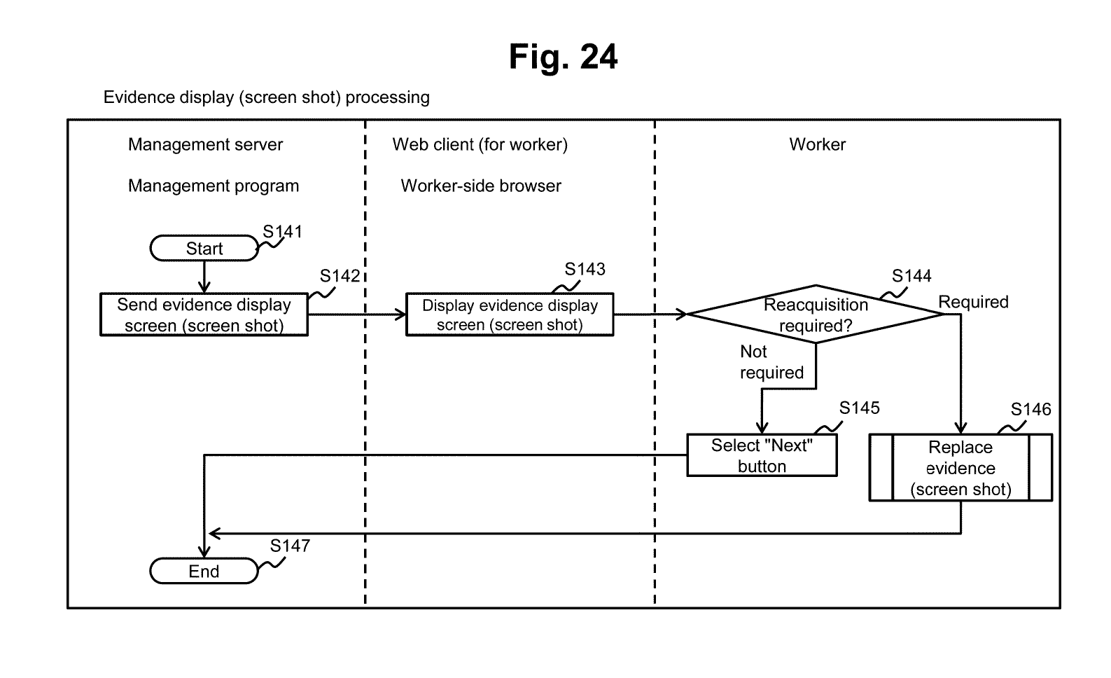

When the type is consequently a screen shot (step S122: screen shot), the management program 121 starts the evidence display processing (evidence display (screen shot) processing) related to the screen shot shown in FIG. 24 (step S123). Meanwhile, when the type is a command execution (step S122: command execution), the management program 121 starts the evidence display processing (evidence display (command execution) processing) related to the command execution shown in FIG. 22 (step S124). Note that, after step S123 or step S124, the management program 121 advances the processing to step S125, and the work is performed by the operator. After the operator confirms all confirmation items, the management program 121 ends the evidence display processing (step S126).

FIG. 22 is a flowchart of the evidence display (command execution) processing according to an embodiment. FIG. 23 is a diagram showing a first example of the evidence display screen according to an embodiment.

The evidence display (command execution) processing is the processing of step S124 in FIG. 21. When the management program 121 of the management server 100 starts the processing (step S131), it creates the evidence display screen (evidence display screen (command execution)) 2400 related to the command execution shown in FIG. 23, and sends the crated evidence display screen 2400 to the operator's Web client 300 (step S132).

Here, the evidence display screen 2400 displays, as shown in FIG. 23, a confirmation item area 2401, an execution example area 2402, an execution result area 2403, a correction button 2404, and a next button 2405.

The confirmation item area 2401 displays the contents of the confirmation item. The execution example area 2402 displays an example (execution example) that is assumed to be displayed on the Web client 300 when the operator executes the work. The execution result area 2403 displays the command execution result. The operator can compare the contents of the execution result area 2403 and the contents of the execution example area 2402, and thereby easily and appropriately perform the confirmation work for determining whether the work was performed appropriately. The correction button 2404 is a button to be pressed upon correcting the execution result. The next button 2405 is a button to be pressed upon advancing to the subsequent work with the current execution result as is.

When the browser 321 of the Web client 300 receives data of the evidence display screen 2400 from the management server 100, it displays the evidence display screen 2400 on the I/O device 330 based on the received data (step S133).

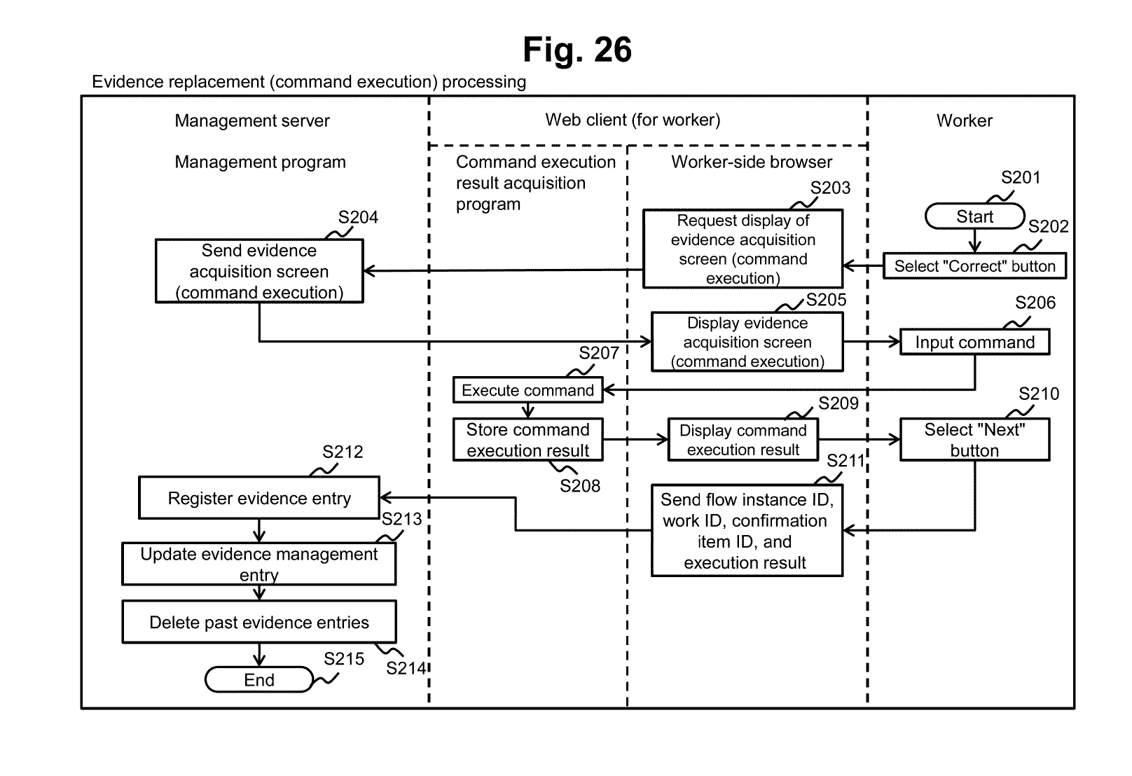

Here, the operator will view the contents of the evidence display screen 2400 and determine whether the execution result needs to be re-acquired (step S134). When the re-acquisition of the execution result is consequently not required (step S134: Not required), the operator presses the next button 2405. Meanwhile, when the re-acquisition of the execution result is required (step S134: Required), the operator presses the correction button 2404, and starts the execution of the evidence replacement processing (evidence replacement (command execution) processing) related to the command execution shown in FIG. 26.

When the next button 2405 of the evidence display screen 2400 is pressed by the operator operating the I/O device 330 of the Web client 300 (step S135), the browser 321 of the Web client 300 closes the evidence display screen 2400, and consequently ends the evidence display processing (step S137). Moreover, when the evidence replacement (command execution) processing is ended, the evidence display processing is also ended (step S137).

FIG. 24 is a flowchart of the evidence display (screen shot) processing according to an embodiment. FIG. 25 is a diagram showing a second example of the evidence display screen according to an embodiment.

The evidence display (screen shot) processing is the processing of step S123 in FIG. 21. When the management program 121 of the management server 100 starts the processing (step S141), it creates the evidence display screen (evidence display screen (screen shot)) 2500 related to the screen shot shown in FIG. 25, and sends the created evidence display screen 2500 to the operator's Web client 300 (step S142).

Here, the evidence display screen 2500 displays, as shown in FIG. 25, a confirmation item area 2501, an execution example area 2502, an acquisition result area 2503, a return button 2504, and a next button 2505.

The confirmation item area 2501 displays the contents of the confirmation item. The execution example area 2502 displays an example (execution example) that is assumed to be displayed on the Web client 300 when the operator executes the work. The acquisition result area 2503 is an area for displaying the thumbnail of the acquired screen shot. Note that, when the thumbnail is pressed, the acquisition result screen 2510 is displayed on the evidence acquisition screen 2500. The acquisition result screen 2510 includes the acquired screen shot 2511, and a correction button 2512 to be pressed for correcting the execution result; that is, for redoing the screen shot. The return button 2504 is a button to be pressed for returning to the previous screen. The next button 2505 is a button to be pressed upon advancing to the subsequent work with the current execution result as is.

When the browser 321 of the Web client 300 receives data of the evidence display screen 2500 from the management server 100, it displays the evidence display screen 2500 on the I/O device 330 based on the received data (step S143).

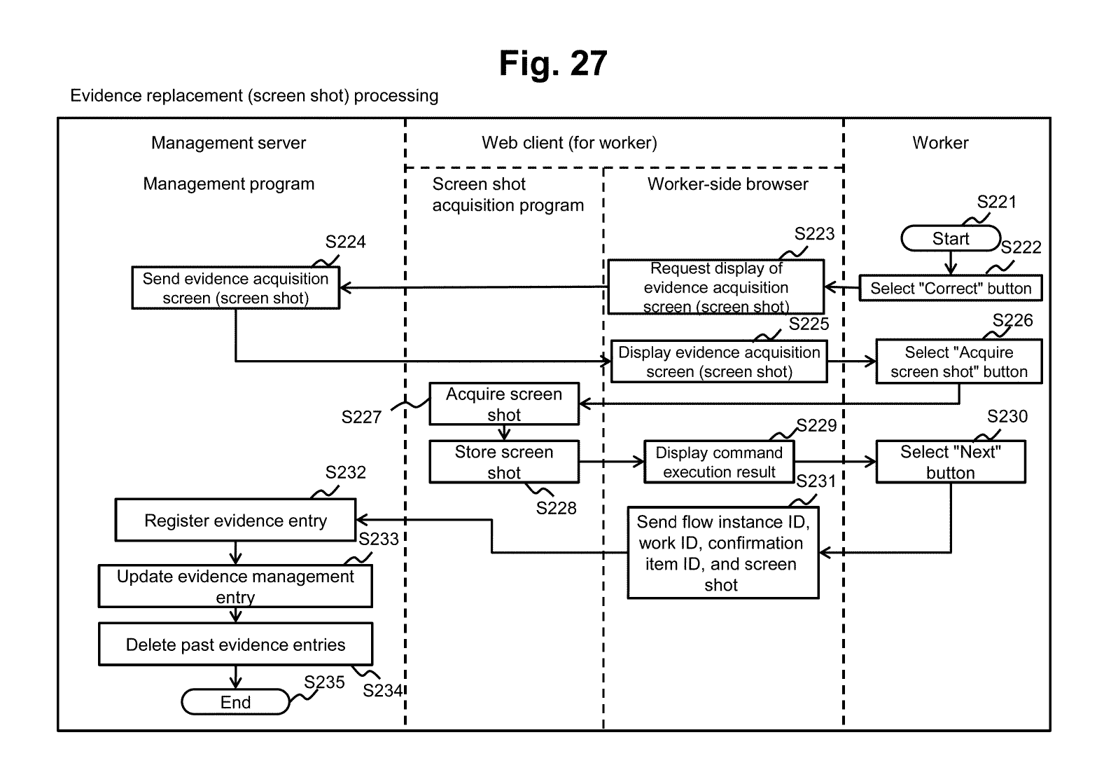

Here, the operator will view the contents of the evidence display screen 2500 and determine whether the execution result needs to be re-acquired (step S144). When the re-acquisition of the execution result is consequently not required (step S144: Not required), the operator presses the next button 2505. Meanwhile, when the re-acquisition of the execution result is required (step S144: Required), the operator presses the correction button 2512, and starts the execution of the evidence replacement processing (evidence replacement (snapshot) processing) related to the snapshot shown in FIG. 27.

When the next button 2505 of the evidence display screen 2500 is pressed by the operator operating the I/O device 330 of the Web client 300 (step S145), the browser 321 of the Web client 300 closes the evidence display screen 2500, and consequently ends the evidence display processing (step S147). Moreover, when the evidence replacement (screen shot) processing is ended, the evidence display processing is also ended (step S147).

FIG. 26 is a flowchart of the evidence replacement (command execution) processing according to an embodiment.

The evidence replacement (command execution) processing is the processing of step S136 in FIG. 22. When the processing is started (step S201) and the correction button 2404 of the evidence display screen 2400 is pressed by the operator operating the I/O device 330 of the Web client 300 (step S202), the browser 321 of the Web client 300 sends a display request of the evidence acquisition screen (command execution) 1700 to the management server 100 (step S203).

Upon receiving the display request of the evidence acquisition screen 1700, the management program 121 of the management server 100 creates the evidence acquisition screen (command execution) 1700 shown in FIG. 18, and sends the created evidence acquisition screen (command execution) 1700 to the operator's Web client 300 (step S204).

When the browser 321 of the Web client 300 receives data of the evidence acquisition screen 1700 from the management server 100, it displays the evidence acquisition screen 1700 on the I/O device 330 based on the received data (step S205).

Here, the operator inputs a command to the console area 1703 of the evidence acquisition screen 1700 and indicates the execution of the command.

When a command is input to the console area 1703 of the evidence acquisition screen 1700 by the operator operating the I/O device 330 of the Web client 300 (step S206), the command execution result acquisition program 322 of the Web client 300 causes a predetermined device to be operated 400 to execute the input command and acquires the execution result thereof (step S207), stores the execution result in the storage resource 320, and notifies the execution result of the command to the browser 321 (step S208).

The browser 321 displays the notified execution result on the console area 1703 of the evidence acquisition screen 1700 (step S209). Consequently, the operator can compare the contents of the execution example area 1702 of the evidence acquisition screen 1700 and the execution result displayed in the console area 1703, and thereby easily and appropriately perform the confirmation work for determining whether the work was performed appropriately.

When the user uses the I/O device 330 of the Web client 300 and presses the next button 1705 (step S210), the browser 321 sends, to the management server 100, the flow instance ID, the work ID, the confirmation item ID, and the command execution result relating to the corresponding confirmation work (step S211).

The management program 121 of the management server 100 acquires the flow instance ID, the work ID, the confirmation item ID, and the command execution result, and registers the evidence entry 1240 regarding the command execution result in the evidence storage table 124 (step S212). Here, the newly allocated evidence ID is stored in the evidence entry ID 1241 of the evidence entry 1240, and information for identifying the area where the command execution result is to be stored is stored in the evidence 1242.

Moreover, the management program 121 of the management server 100 updates the evidence management entry 1250 related to the evidence corresponding to the evidence management table 125 (step S213), deletes the past (pre-correction) evidence management entry 1250 of the evidence storage table 124 (step S214), and ends the evidence replacement (command execution) processing (step S215).

According to the foregoing evidence replacement (command execution) processing, the executed result of the re-executed command processing can be easily and appropriately managed by being associated with the work of the flow instance. It is thereby possible to appropriately prevent evidence from being associated with a wrong work.

FIG. 27 is a flowchart of the evidence replacement (screen shot) processing according to an embodiment.

The evidence replacement (screen shot) processing is the processing of step S146 in FIG. 24. When the processing is started (step S221) and the correction button 2512 of the acquisition result screen 2510 is pressed by the operator operating the I/O device 330 of the Web client 300 (step S222), the browser 321 of the Web client 300 sends a display request of the evidence acquisition screen (screen shot) 1900 to the management server 100 (step S223).

Upon receiving the display request of the evidence acquisition screen 1900, the management program 121 of the management server 100 creates the evidence acquisition screen (screen shot) 1900 shown in FIG. 20, and sends the created evidence acquisition screen (screen shot) 1900 to the operator's Web client 300 (step S224).

When the browser 321 of the Web client 300 receives data of the evidence acquisition screen 1900 from the management server 100, it displays the evidence acquisition screen 1900 on the I/O device 330 based on the received data (step S225).

Here, the operator presses the screen shot acquisition button 1903 of the evidence acquisition screen 1900 and indicates the acquisition of the screen shot of the configuration screen of the device to be operated 400.

When the screen shot acquisition button 1903 of the evidence acquisition screen 1900 is pressed by the operator operating the I/O device 330 of the Web client 300 (step S226), the screen shot acquisition program 323 of the Web client 300 acquires, from the device to be operated 400, and displays a screen for displaying the configuration information of the device to be operated 400, acquires the screen shot of that screen (step S227), stores the screen shot in the storage resource 320, and delivers the screen shot to the browser 321 (step S228).

The browser 321 displays the thumbnail of the notified screen shot in the acquisition result area 1904 of the evidence acquisition screen 1900 (step S229). It is thereby possible to display the acquisition result screen 1910 when the operator presses the acquisition result area 1904 of the evidence acquisition screen 1900, and the operator can thereby compare the contents of the execution example area 1902 and the execution result (screen shot) displayed on the acquisition result screen 1910, and thereby easily and appropriately perform the confirmation work for determining whether the work was performed appropriately.

When operator uses the I/O device 330 of the Web client 300 and presses the next button 1906 (step S230), the browser 321 sends, to the management server 100, the flow instance ID, the work ID, the confirmation item ID, and the screen shot related to the corresponding confirmation work (step S231).

The management program 121 of the management server 100 acquires the flow instance ID, the work ID, the confirmation item ID, and the screen shot, and registers the evidence entry 1240 regarding the screen shot in the evidence storage table 124 (step S232). Here, the newly allocated evidence ID is stored in the evidence entry ID 1241 of the evidence entry 1240, and information for identifying the area where the screen shot is to be stored is stored in the evidence 1242.

Moreover, the management program 121 of the management server 100 updates the evidence management entry 1250 related to the evidence corresponding to the evidence management table 125 (step S233), deletes the past (pre-correction) evidence management entry 1250 of the evidence storage table 124 (step S234), and ends the evidence replacement (screen shot) processing (step S235).

According to the foregoing evidence replacement (screen shot) processing, the executed result (screen shot) that was re-acquired can be easily and appropriately managed by being associated with the work of the flow instance. It is thereby possible to appropriately prevent evidence from being associated with a wrong work.

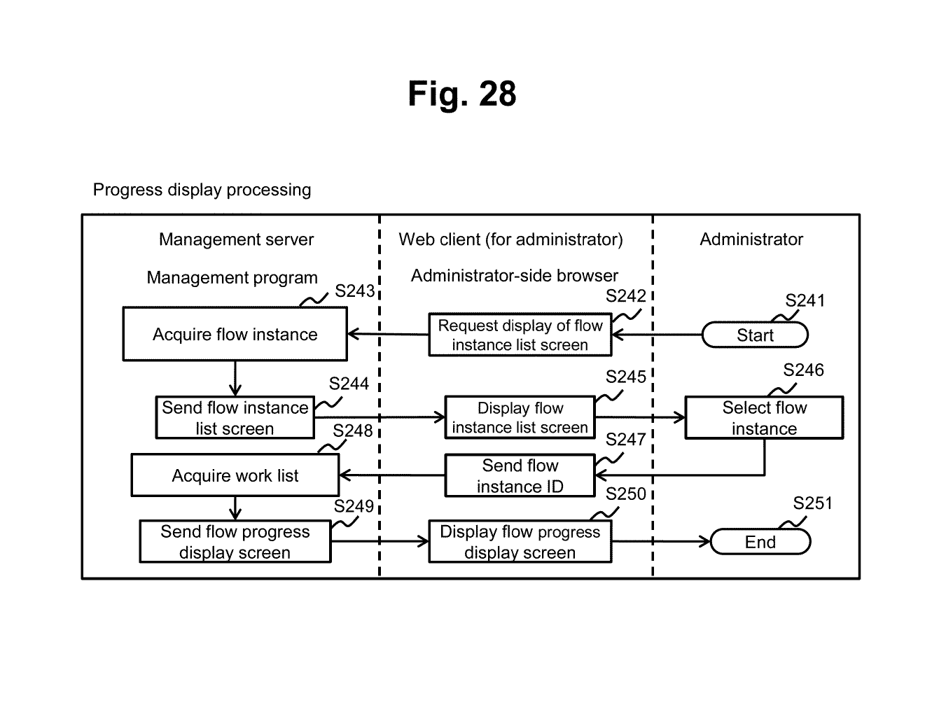

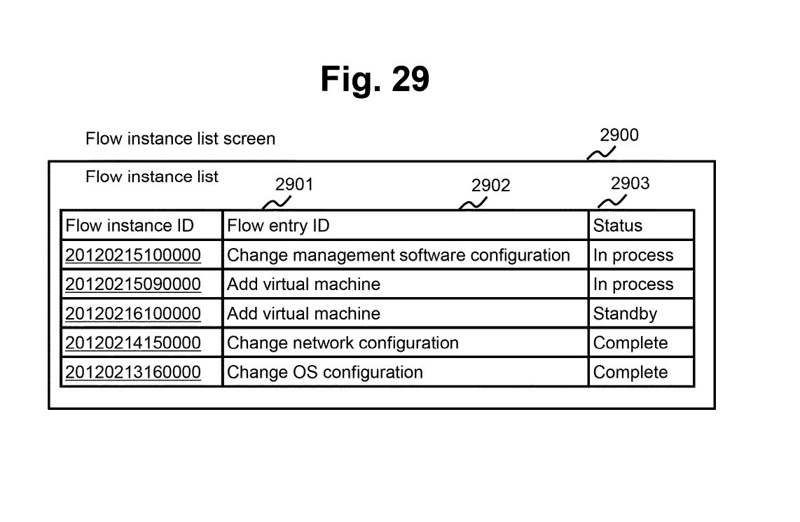

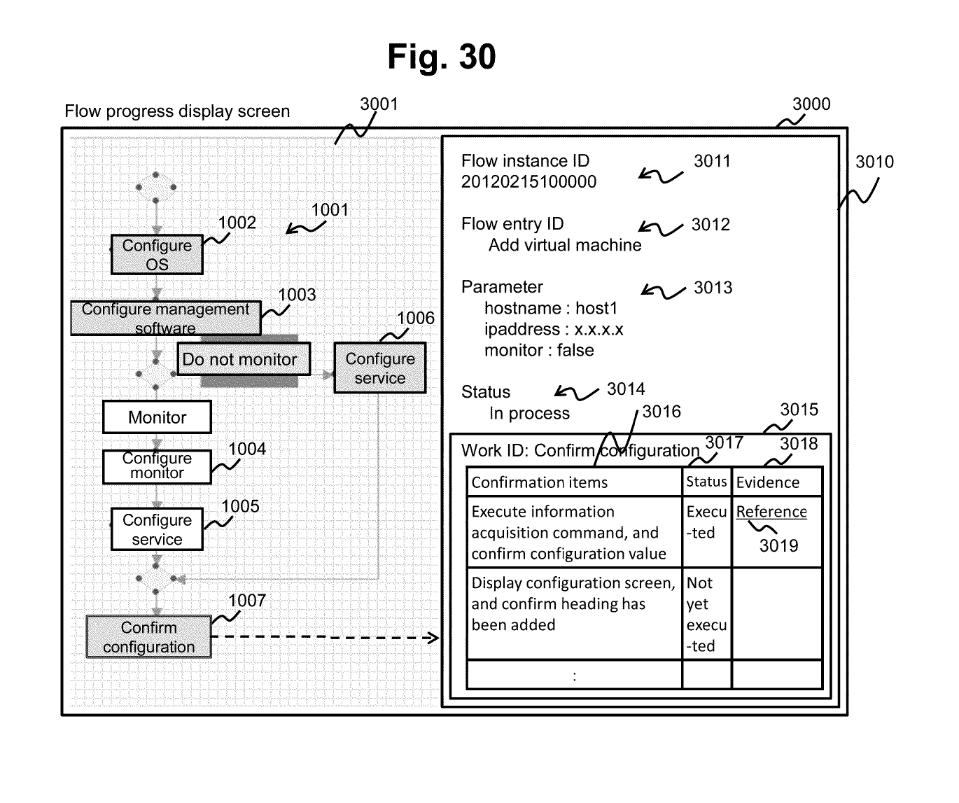

FIG. 28 is a flowchart of the progress display processing according to an embodiment. FIG. 29 is a diagram showing an example of the flow instance list screen according to an embodiment. FIG. 30 is a diagram showing an example of the flow progress display screen according to an embodiment.

The progress display processing is the processing that is executed when the administrator is to confirm the status of progress of the flow instance.

When the administrator starts the operation by using the I/O device 230 of the Web client 200 and performs a display request operation of a flow instance list screen (step S241), the browser 221 of the Web client 200 sends a display request of the instance list screen to the management server 100 (step S242). The management program 121 of the management server 100 acquires the flow instance entry 1230 from the flow instance management table 123 (step S243), creates the flow instance list screen 2900 shown in FIG. 29, and sends the created flow instance list screen 2900 to the administrator's Web client 200 (step S244).

Here, the flow instance list screen 2900 displays, as shown in FIG. 29, a flow instance ID area 2901, a flow entry ID area 2902, and a status area 2903.

The free instance ID area 2901 selectively displays one or more flow instance IDs. Here, when any one of the flow instance IDs is selected, a flow progress display screen (refer to FIG. 30) showing the progress in the flow instance corresponding to the selected flow instance ID is displayed. The flow entry ID area 2902 displays a flow entry ID of the flow that was the basis of the corresponding flow instance. The status area 2903 displays the progress status of the work of the corresponding flow instance.

When the browser 221 of the Web client 200 receives data of the flow instance list screen 2900 from the management server 100, it displays the flow instance list screen 2900 on the I/O device 230 based on the received data (step S245).

When the flow instance ID of the flow instance ID area 2901 is selected by the administrator operating the I/O device 230 of the Web client 200 (step S246), the browser 221 sends the corresponding flow instance ID to the management server 100 (step S247).

The management program 121 of the management server 100 receives the flow instance ID, acquires the corresponding flow instance entry 1230 of the flow instance management table 123 based on the flow instance ID, acquires the corresponding flow entry 1220 from the flow management table 122 based on a value of the flow entry ID 1232 of the flow instance entry 1230, and identifies the confirmation item and evidence regarding the work in the corresponding flow instance in the evidence management table 125 and the evidence storage table 124 based on the values of the respective fields of the flow entry 1220 (step S248).

Subsequently, the management program 121 of the management server 100 creates the flow progress display screen 3000 shown in FIG. 30 based on each of the acquired information, and sends the created flow progress display screen 3000 to the administrator's Web client 200 (step S249).

Here, the flow progress display screen 3000 displays, as shown in FIG. 30, a flow display area 3001, and a confirmation item list area 3010. The flow display area 3001 displays, in a flowchart format, the components (1002 to 1007) showing the one or more works in the corresponding flow instance. The components (1002 to 1007) showing the respective works are displayed in different forms depending on the progress status of the corresponding work. In this embodiment, the display colors of the background of the components are caused to differ for work that is in process, work that was completed, and work that has not yet been executed. Here, when the component corresponding to the work including the confirmation heading (in the example of FIG. 30, component 1007 of the work of “configuration confirmation”) is pressed, the confirmation item list area 3010 is displayed.

The confirmation item list area 3010 displays a flow instance ID area 3011, a flow entry ID area 3012, a parameter area 3013, a status area 3014, and a confirmation heading area 3015. The flow instance ID area 3011 displays the corresponding flow instance ID. The flow entry ID area 3012 displays the corresponding flow entry ID. The parameter area 3013 displays the parameters and the configuration values in the flow instance. The status area 3014 displays the status of the corresponding work.

The confirmation heading area 3015 displays a confirmation item area 3016, a status area 3017, and an evidence area 3018 for each confirmation item. The confirmation item area 3016 displays the contents of the confirmation item. The status area 3017 stores the status of work of the corresponding confirmation item. The evidence area 3018 stores a link 3019 for referring to the evidence regarding the work of the corresponding confirmation item. Note that the evidence area 3018 may also display the evidence.

When the browser 221 of the Web client 200 receives data of the flow progress display screen 3000 from the management server 100, it displays the flow progress display screen 3000 on the I/O device 230 based on the received data (step S250).

Subsequently, by selecting the component (for example, component 1007) showing the work including the confirmation heading of the flow progress display screen 3000, the administrator can display the confirmation item list area 3010 in the work indicated by the corresponding component, and thereby confirm the status of the respective confirmation items and the evidence regarding the respective confirmation items. Note that, by the administrator performing the operation of closing the flow progress display screen 3000, the browser 221 closes the flow progress display screen 3000, and the progress display processing is thereby ended (step S251).

An embodiment of the present invention was explained above, but the present invention is not limited to the foregoing embodiment, and may be applied in various other modes.

### REFERENCE SIGNS LIST

100 Management server

200, 300 Web client

400 Device to be operated

1. A work management method performed by a management system that manages works performed to a predetermined target device,
the method comprising the steps of:
storing, in a storage device, a first work definition showing one or more first works to be performed by an operator to the target device, a second work definition showing a second work for acquiring evidence for confirming a result of one first work among the one or more first works, and flow information including order information prescribing an execution order of the first work and the second work;
determining whether the timing has come to execute the second work based on the flow information;
performing a support display for causing the operator to acquire the evidence when the timing has come to execute the second work; and
storing the evidence acquired based on the support display in the storage device by associating the acquired evidence with the flow information.

2. A work management method according to claim 1, further comprising:
receiving a designation of work that has acquired evidence to be displayed; and
identifying the evidence acquired in the work and displaying the evidence based on the designation of the work and the flow information.

3. A work management method according to claim 2, further comprising:
performing a support display for acquiring new evidence when a correction indication for correcting the displayed evidence is received; and
storing, in the storage device, the new evidence that has been acquired based on the support display as evidence to be associated with the flow information.

4. A work management method according to claim 3, wherein
the evidence includes a result of a command for acquiring configuration information on the target device;
the support display includes a console area for inputting the command,
the work management method further comprising:
causing the handling device to execute the command to acquire the configuration information from the target device, and display the result in the console area when the command is input to the console area; and
storing, in the storage device, the result displayed in the console area by associating the displayed result with the flow information.

5. A work management method according to claim 3,
wherein the evidence includes a screen shot of a configuration result screen of the target device;
wherein the support display includes an acquisition indication button for indicating an acquisition of the screen shot of the configuration result screen of the target device,
wherein the work management method further comprising:
acquiring the screen shot of the configuration result screen of the target device, and storing, in the storage device, the screen shot by associating the acquired screen shot with the flow information when the acquisition indication button is pressed.

6. A work management method according to claim 4, further comprising:
displaying an execution result example of the command on a same screen as the console area.

7. A work management method according to claim 5, further comprising:
displaying an execution result example of the screen shot on a same screen as the acquired screen shot.

8. A work management method according to claim 3, further comprising:
receiving a designation of a workflow for displaying a progress; and
displaying the progress of the respective works corresponding to the workflow based on the flow information and the evidence, and displaying the evidence acquired in the workflow or displaying an indication component for displaying the evidence.

9. A management system which comprises a storage device and a control device coupled to the storage device, and manages works performed to a predetermined target device,
wherein the storage device is configured to store a first work definition showing a first work to be performed by an operator to the target device, a second work definition showing a second work for acquiring evidence for confirming a result of one work among one or more actual works, and flow information including order information prescribing an execution order of the first work and the second work; and
wherein the control device is configured to:
determine whether the timing has come to execute the second work based on the flow information;
perform a support display for causing the operator to acquire the evidence when the timing has come to execute the second work; and
store the evidence acquired based on the support display in the storage device by associating the acquired evidence with the flow information.

10. The management system according to claim 9,
wherein the control device is configured to:
receive a designation of work that acquired evidence to be displayed; and
identify the evidence acquired in the work and displaying the evidence based on the designation of the work and the flow information.

11. The management system according to claim 9,
wherein the control device is configured to:
perform a support display for acquiring new evidence when a correction indication for correcting the displayed evidence is received; and
store, in the storage device, the new evidence that was acquired based on the support display as evidence to be associated with the flow information.

12. The management system according to claim 9,
wherein the evidence includes a result of a command for acquiring configuration information of the target device;
wherein the support display includes a console area for inputting the command; and
wherein the control device is configured to:
cause the target device to execute the command, acquires the configuration information from the target device, and displays the result in the console area when the command is input to the console area; and
store, in the storage device, the result displayed in the console area by associating the displayed result with the flow information.

13. The management system according to claim 9,
wherein the evidence includes a screen shot of a configuration result screen of the target device;
wherein the support display includes an acquisition indication button for indicating an acquisition of the screen shot of the configuration result screen of the target device; and
wherein the control device is configured to:
acquire the screen shot of the configuration result screen of the target device, and
store, in the storage device, the screen shot by associating the acquired screen shot with the flow information when the acquisition indication button is pressed.
